(19) United States
(12) Patent Application Publication
(10) Pub. No.: US 2013/0124222 A1
(43) Pub. Date: May 16, 2013

(54) METHOD AND SYSTEM MANAGING AND PROCESSING PATIENT DATA

(71) Applicants: Boris Bruce Nashtut, San Diego, CA (US); Renee Michelle Nashtut, San Diego, CA (US)

(72) Inventors: Boris Bruce Nashtut, San Diego, CA (US); Renee Michelle Nashtut, San Diego, CA (US)

(73) Assignee: TURBOTAR, INC., San Diego, CA (US)

(21) Appl. No.: 13/295,033

(22) Filed: Nov. 11, 2011

(51) Int. Cl. G06Q 50/24

(52) U.S. Cl. 705/3

(57) ABSTRACT

A computer-implemented device system and method for creating, managing, and processing an interactive workflow is described to handle patient data. A client having various modules may be installed on a computing device. The modules of the client may be adapted to receive and transmit communications by way of various communication methods. The client may be in direct or indirect communication with a server, which includes one or more databases and a host application having various modules and engines that facilitate communications between a user and one or more entities associated with healthcare including insurers, patients, doctors, physical therapists occupations therapists, speech therapists, allied healthcare professionals, nurses and other skilled professionals.

### FIELD OF THE INVENTION

This invention relates to workflow management systems and methods, and more particular, to methods and systems for managing and processing patient data.

### BACKGROUND

The healthcare industry is evolving. Healthcare providers are constantly required to ensure that they comply with current rules and regulations at the federal, state, and local level. In addition, due the heightened sensitivity associated with patient information, healthcare providers generate significant amounts of documentation including patient assessments, progress records, and medical communications. Each of these tasks is expensive and requires a significant allocation of resources. Further, many healthcare providers have trouble consolidating patient data so that it is easy to use.

Along with documentation and compliance, healthcare providers and patients may have a contract with an insurance company. When the patient seeks treatment, the healthcare provider may contact the health insurance provider to determine what treatments are covered by the patient's health plan. The insurer may cover some or the entire amount of the patient's treatment. To determine coverage, the insurer and the healthcare provider use specific codes for different types of treatments. Associated with each code is an amount that the insurer pays to the healthcare provider. In many cases, the insurer does not pay for the treatment, unless the appropriate documentation is received during the billing process.

Therefore, there is a need for a method and system that ensures compliance and makes billing and documentation easy to manage and process.

### SUMMARY

A computer-implemented device system and method for creating, managing, and processing an interactive workflow is described to handle patient data. A client having various modules may be installed on a computing device. The modules of the client may be adapted to receive and transmit communications by way of various communication methods. The client may be in direct or indirect communication with a server, which includes one or more databases and a host application having various modules and engines that facilitate communications between a user and one or more entities associated with healthcare including insurers, patients, doctors, physical therapists occupations therapists, speech therapists, allied healthcare professionals, nurses and other skilled professionals.

### BRIEF DESCRIPTION OF THE DRAWINGS

FIG. 1 is an example of a system in an embodiment.

FIG. 2 is an example of system in an embodiment.

FIGS. 2A-2G illustrate various modules of the system in an embodiment.

FIG. 3 is an example of a login screen.

FIGS. 4-9 illustrate example screenshots of a Participant Information and/or a service provider Screen (“PIS”) in accordance with various embodiments.

FIGS. 10-15 illustrate example screenshots of the Medications Screen in accordance with various embodiments.

FIGS. 16-26 illustrate example screenshots of a Progress Notes Screen (“PNS”) in accordance with various embodiments.

FIGS. 27-35 illustrate example screenshots of a Care Planning Screen (“CPS”) in accordance with various embodiments.

FIG. 36 illustrates an example of a screenshot for deleting a care plan.

FIGS. 37-39 illustrate example screenshots of quarterly and reauthorization notes.

FIG. 40 illustrates example screenshots showing how to add a Treatment Authorization Request (“TAR”) in an embodiment.

FIG. 41 illustrate an example screenshot of an Initial Plan of Care Screen (“IPCS”) in various embodiments.

FIGS. 42A and 42B illustrate screenshots for adding a diagnosis for FIGS. 43-46 illustrate example screenshots showing how to add and/or search for International Statistical Classification of Diseases (“ICD-9”) codes in various embodiments.

FIGS. 47-49 illustrate example screenshots for adding participant pictures.

FIGS. 50-52 illustrate example screenshots showing how to add one or more users in various embodiments.

FIGS. 53 and 54 illustrate an example screenshot for changing a password.

FIG. 54A illustrates an example screenshot for Community Outreach (“CO”) program.

FIGS. 55-58 show a workflow for adding, checking the status, and generating a report for a prospect.

FIG. 59 illustrates a Transaction History (“TH”) form in an example.

FIGS. 60-62 illustrate example screenshots concerning managing a workflow including an online overview in various embodiments.

FIG. 63 illustrates an exemplary workflow for providing transportation for a participant.

FIGS. 65-66A-illustrate example screenshots of adding a daily schedule in various embodiments

FIG. 67 illustrates an example screenshot of the grid and its functionality in an embodiment.

FIG. 67A illustrates an example of a screenshot for creating a schedule.

FIGS. 68-72 illustrate example screenshots concerning TARs.

FIG. 73 illustrates an example screenshot of a TAR form that has been updated after submission. The information that has been altered may be automatically populated and updated.

FIGS. 74-76 illustrate an example of how to print a report.

FIG. 77 illustrates a MSRR report.

FIG. 78 illustrates a participant characteristics report

### DETAILED DESCRIPTION

A computer-implemented system and method configured on one or more devices for creating, managing, and processing an interactive workflow is described to handle patient data. A client having various modules may be installed on a computing device. The modules of the client may be adapted to receive and transmit communications by way of various communication methods. The client may be in direct or indirect communication with a server, which includes one or more databases and a host application having various modules and engines that facilitate communications between a user and one or more entities associated with healthcare including insurers, patients, doctors, physical therapists occupations therapists, speech therapists, allied healthcare professionals, and nurses.

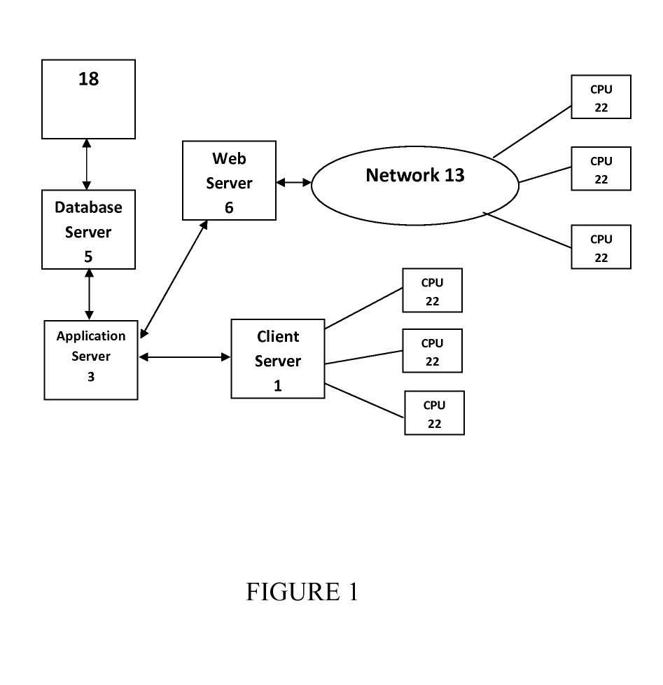

FIG. 1 illustrates an embodiment a system for managing patient information shown as 15. The system 15 includes a client server 1 that is coupled to an application server 3, database server 5, and/or a web server 6. In one embodiment, the client server 1 may include one or more computers 22.

The client server 1 may communicate directly or indirectly with the web server 6, database server 5, and/or application server 3 through a wired or wireless connection. In one embodiment, the client server 1 may be coupled to a public or private network via web server 6. The network may be the Internet, a private network, or other similar network.

Referring again to FIG. 1, the database server 5 may be coupled to a database 18. The database 18 may be any suitable database, for example, a relational database. The database 18 may be configured to store a variety of information, including patient data, medical data, and/or billing information. The database server 5 may also include an interface to an external server or application server that is coupled to a health care facility. A client computer 22 coupled to the client server 1 may include a user interface including a display, keyboard, and pointer may be coupled to one or more components of the system. The client computer 22 may be any general purpose device having a CPU. The client computer 22 may be a mobile device and may be configured to operate over any type of network including a wired and wireless network.

The system 15 may include may include a module for logging in and authenticating a user 25, module for providing various levels of security 26, a participant's module 28, a Treatment Authorization Request (TAR) module 29, a reports module 30, an administration module 31, community outreach module 32, a billing module 33, medications module 34, a progress notes module 35, a care plan module 36, and a scheduling module 37. Each of the above modules may be configured independently or integrated together as one or more processes depending on the configuration. In one embodiment the system is configured as a single process, where one or more modules are instantiated at power-up of the system. In this way, the ability to activate and switch between modules is simple quick, and seamless and requires little processing time or power. Various modules may be linked together using pointers or other similar techniques.

In one embodiment, system 15 may be configured to an Adult Day Healthcare facility operating with Medi-Cal. However, the system may be configured to interface with other types of systems or facilities. For example, the system 15 may be configured to operate with an ADT system. Patient or participant data may be received electronically from a health care facility, government entity, database, or other entity or device, such as a client computer, or entered manually by a healthcare provider, etc.

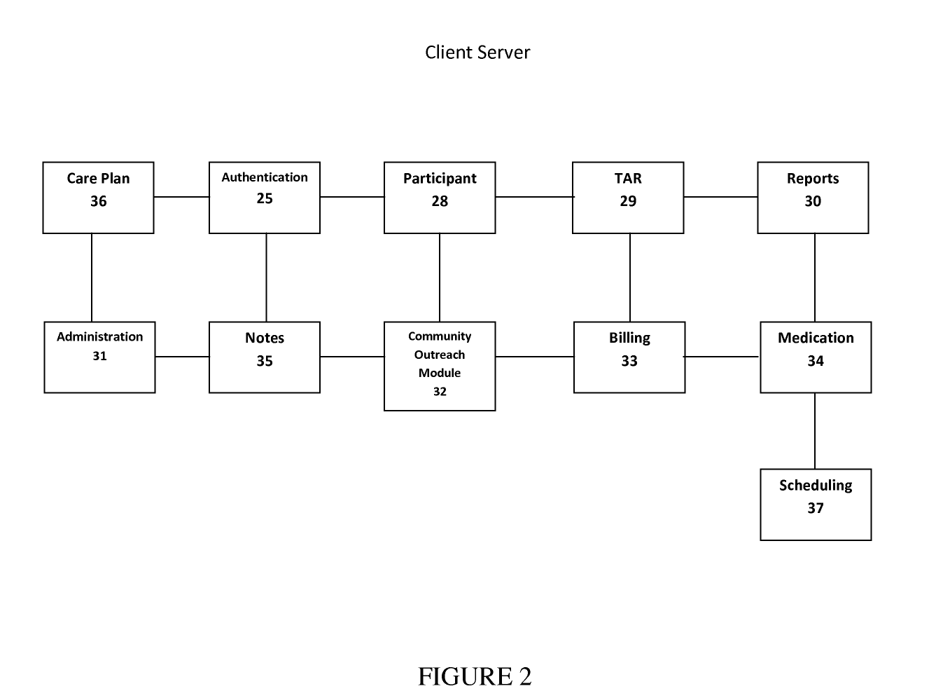

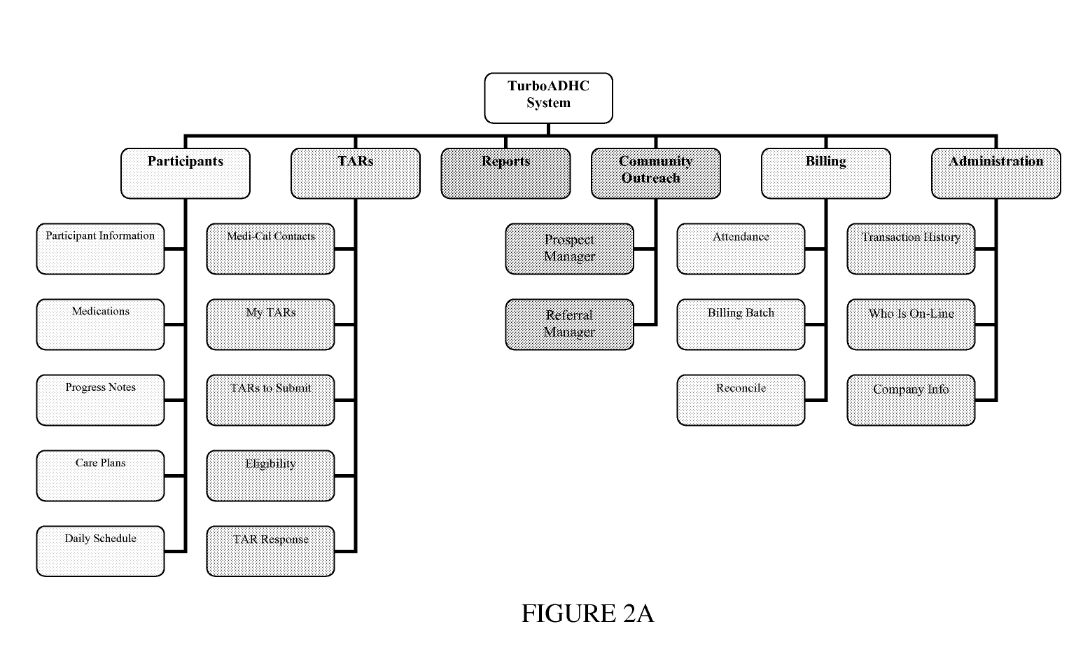

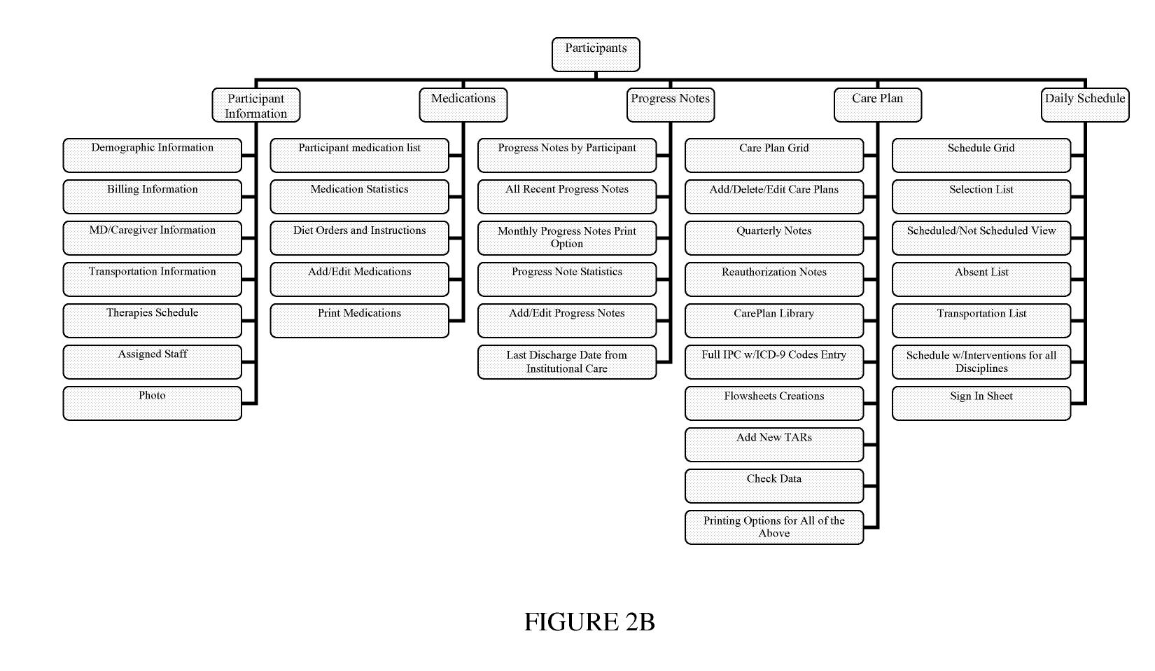

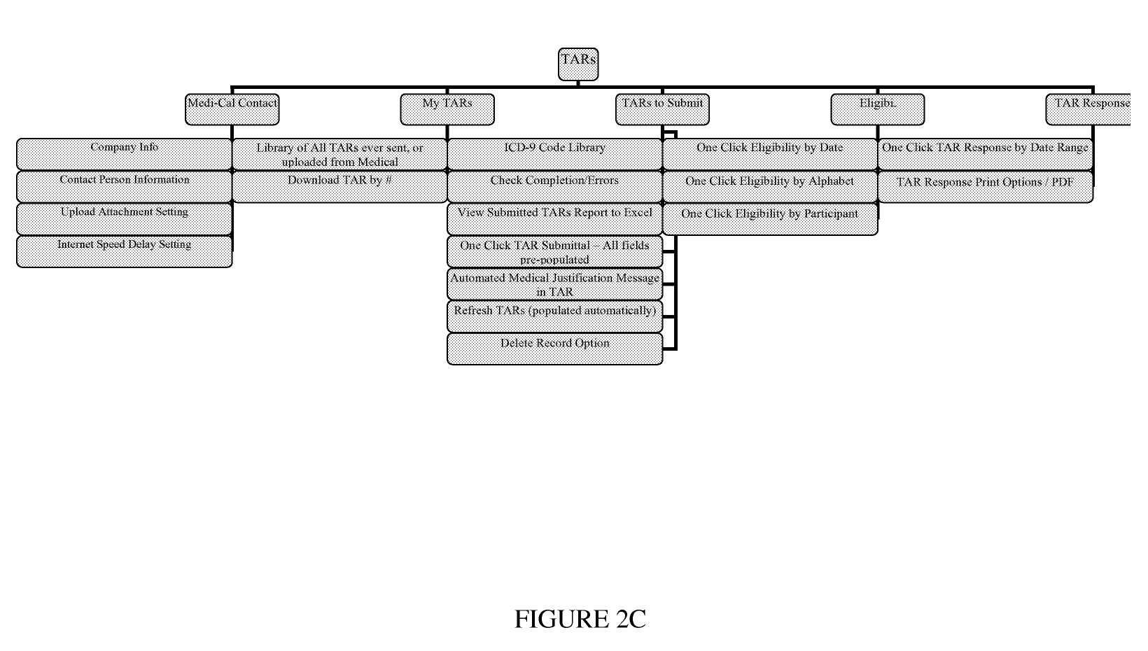

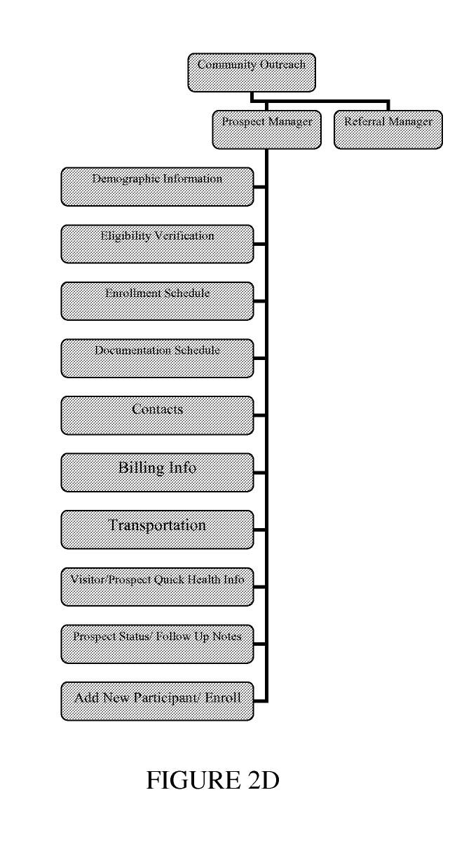

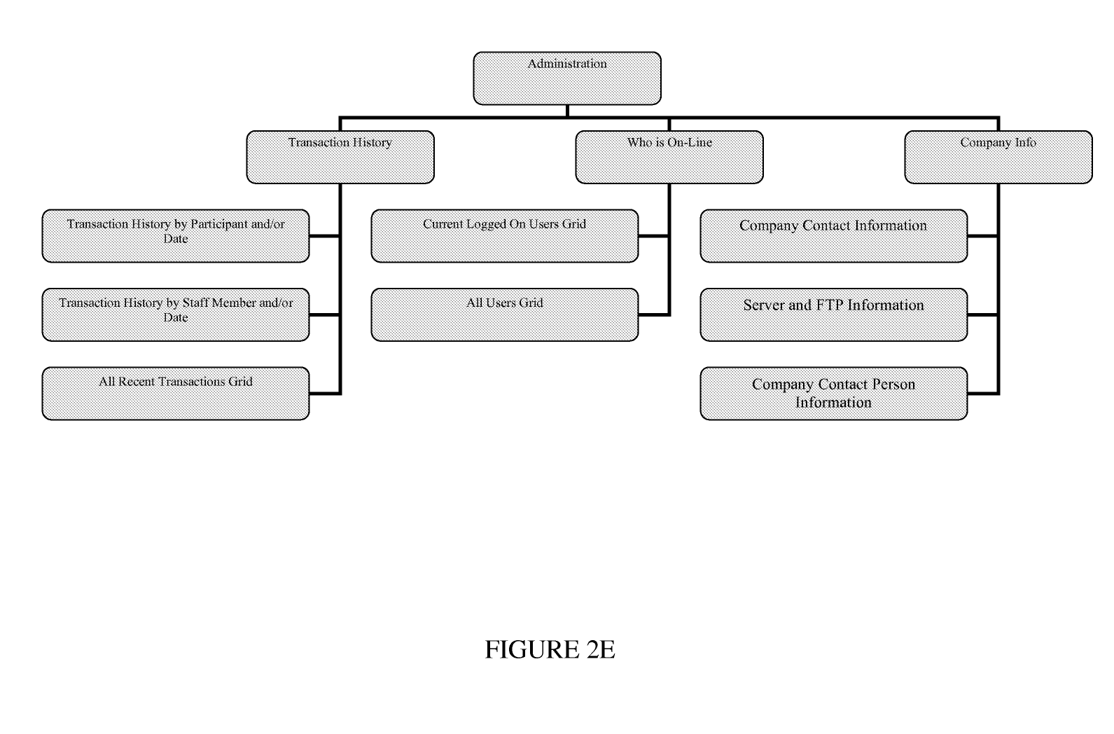

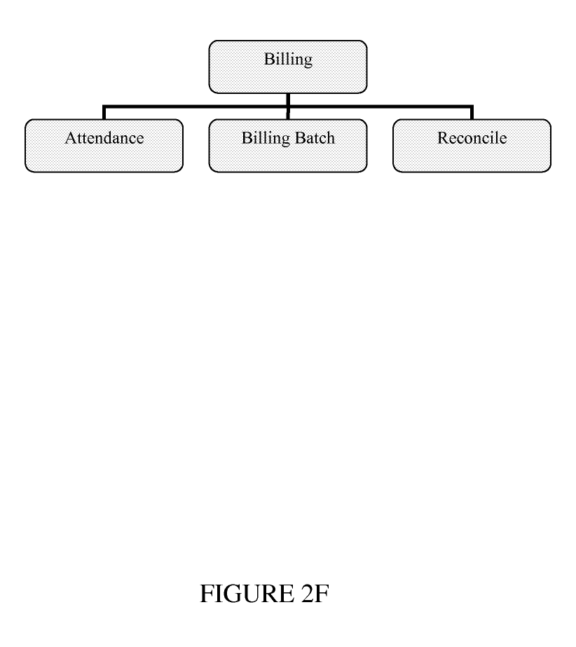

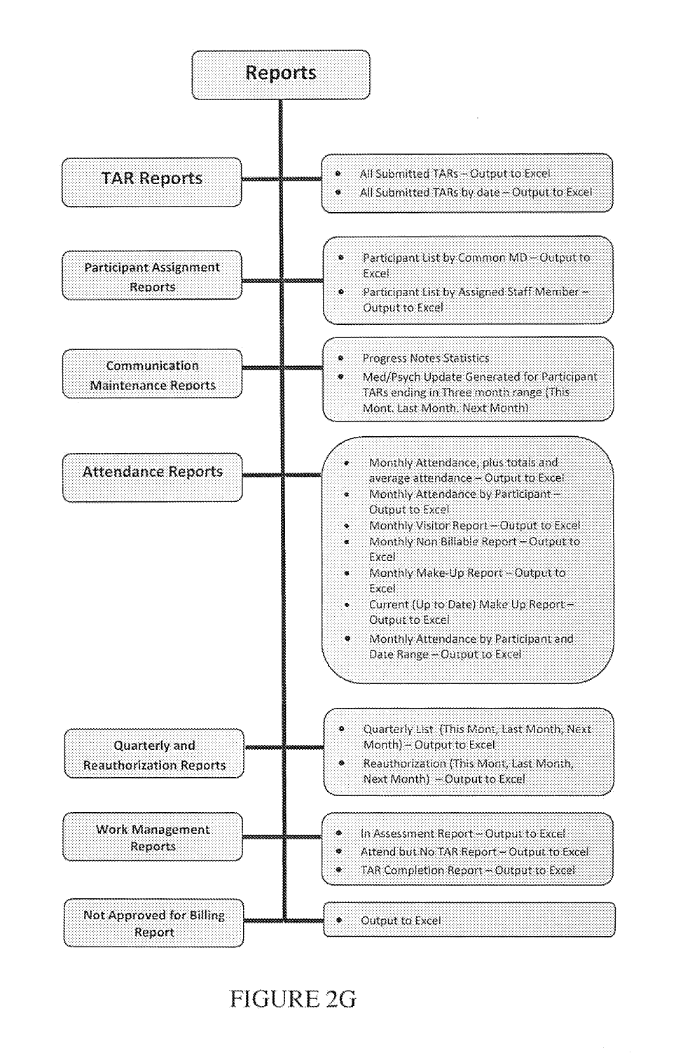

Referring to FIG. 2, various tables and fields may be in the database 18. The data stored in the database is referred to as patient data meaning the data is associated with a patient. The stored data is formatted such that the system 15 is capable of accessing and updating many different data fields related to the patient as well as current, historical, and future information associated with the operation of the system.

Referring again to FIG. 1, the database 18 may include information about the patient including identification information, status information, and/or other healthcare information associated with the patent. The database 18 may be provided as a database management system (DBMS), and, in particular, as a relation database management system (RDBMS) or an object database management system (ODBMS). Further, the database may be accessed using a database query language. Examples include such as SQL, MySQL, or Oracle.III. The database 18 may be updated by the database server 6 throughout the operation of the system 15 in response to requests by system administrators, authorized users, a server computer, a computer, or other client requests.

Referring again to FIG. 1, the system 15 may include a log-in authentication module 25 for processing user log-in requests for system. The authentication may be configured using electronic signatures. The authentication module 25 may function independently of the health care facility network and assign and utilize individual user login identification and passwords that are stored in the database 18 for a user of the system 15. Alternatively, the login module 34 is coupled to the health care facility's network such that the health care facility's login system is used to authenticate a user's request to access the system. A LDAP server may be utilized by the health care facility for user authentication. Additionally, the authentication module 25 may track and store data as to the use of various devices on the network including client computers 22 and logins and logouts for the system 15.

Additionally, a security module may be coupled to one or more servers in FIG. 1 for controlling user access to the system as well as tracking all user activity within the system. The security module may be configured to provide various levels of authentication, task access, and other security attributes.

Accordingly, the security module may control the use of system on a task by task basis, wherein authorization for each requested task is verified based on the role of the user before the task is executed. The security module is variably configured to ensure that the system satisfies HIPPA requirements including those related to patient privacy.

The system 15 may also include a message handler and an associated information module to enable the movement of information between external devices and applications. For example, the system 15 may be configured to provide healthcare information from web servers or other external devices in the health care facility.

FIGS. 2A-2G illustrate various embodiments of modules to be executed to perform one or more processes that may be configured for the system 15. The modules may be configured in a combination of software and/or hardware. FIG. 2A illustrates a top level diagram the participant's module 28, the Treatment Authorization Request (TAR) module 29, the reports module 30, the administration module 31, community outreach module 32, a billing module 33; Examples of various embodiments for these modules are described herein. Each of the modules and sub-modules in FIGS. 2A-2G are represented by boxes in hierarchical fashion. In one embodiment, any module or sub module may be accessed using a tab on a user interface or from a drop down menu. Once the module is selected, one or more of the sub-modules may be accessed. For example, accessing the billing module in FIG. 2G would make available the sub modules “Attendance,” Billing Batch,” and “Reconcile.” The modules and sub-modules may be configured with a single push button or clicking technology enabling the module to be executed. In one embodiment, the tabs or drop down menu may be used to seamlessly switch between modules and sub-modules in a top down or side by side approach. Such a configuration makes navigation through the hierarchy of modules and sub-modules seamless.

In an embodiment, the modules and sub-modules may be shared even at the same level. For example, while accessing the “All User's Grid” in FIG. 2F, “Company Contact Information” may be accessed without having to navigate to “Who is On-Line” to ‘Company Info” and then to Company Information. Therefore, one can navigate top down or between modules and sub modules or any other configuration suitable for a given application.

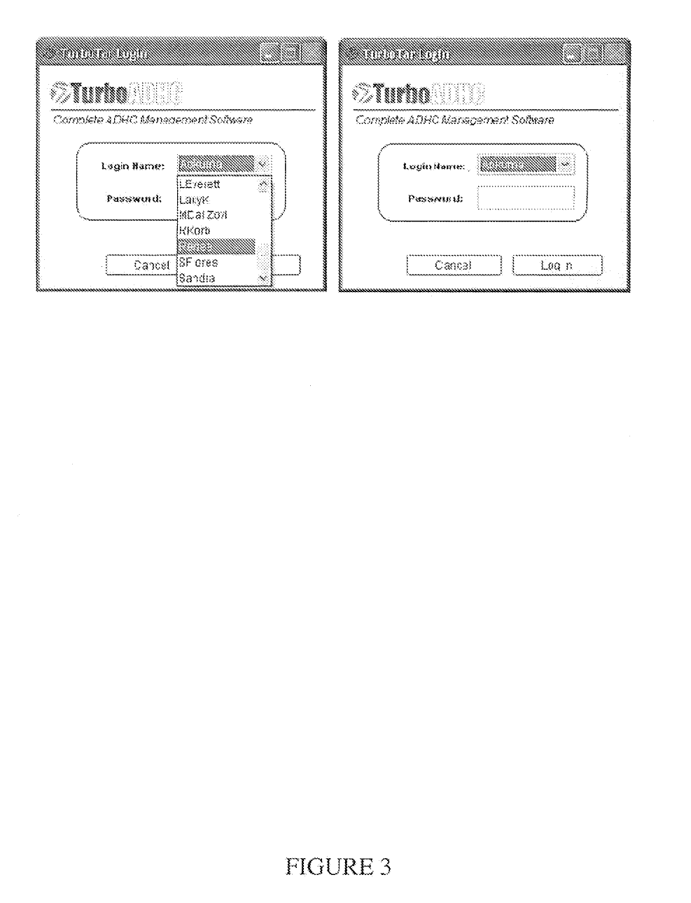

FIG. 3 illustrates a screen 30 that may configured to enable one more users to login into the system The system may be configured to receive a login name and associated password that identifies a unique user. A login name may be selected from a pull-down menu. The system may verify and/or authenticate one or more users when the LOGIN button is activated

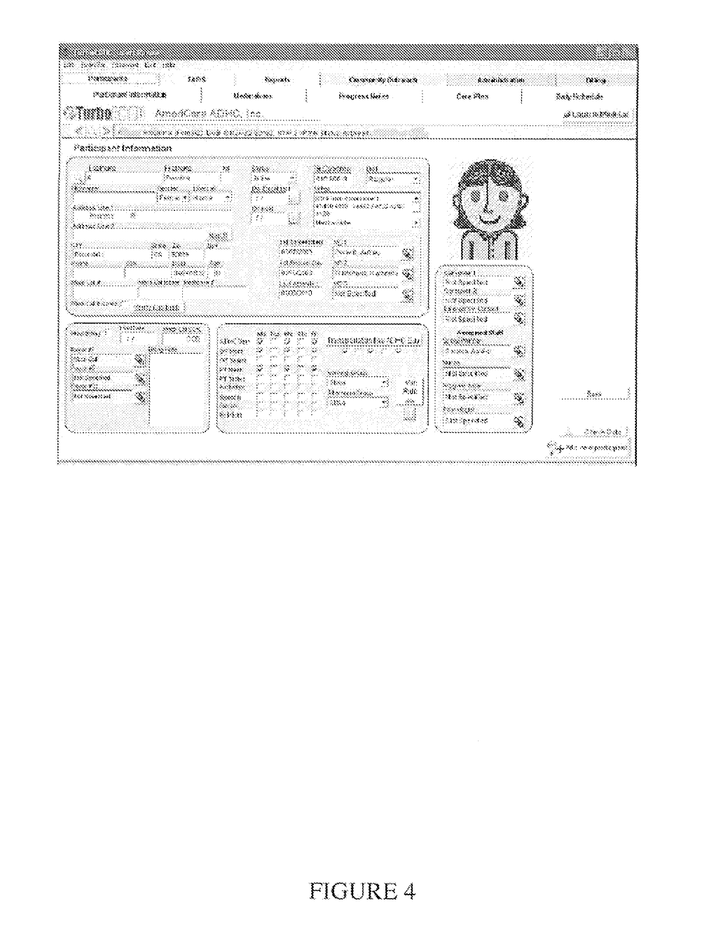

FIG. 4 illustrates a user interface that may be configured to provide substantially all information necessary to complete a patient workflow as described herein including one or more steps required to identify a patient to complete billing for a patient's treatment.

In one embodiment, the user interface provides a visual representation of the various modules of the system. For example, the user interface may display participant information, billing information, scheduling information, and/or caregiver information. The various types of information may be depicted in one or more regions of the user interface. The user interface may be configured to show visually depict the various modules and business logic that supports patient workflow including billing, assign a billing entity, billing preferences, billing, TARs, medications progress notes, care plans, daily schedules, reports, administration, and/or community outreach. Other types of information are also possible including patient contacts. The various types of information may be accessed using one or more tabs.

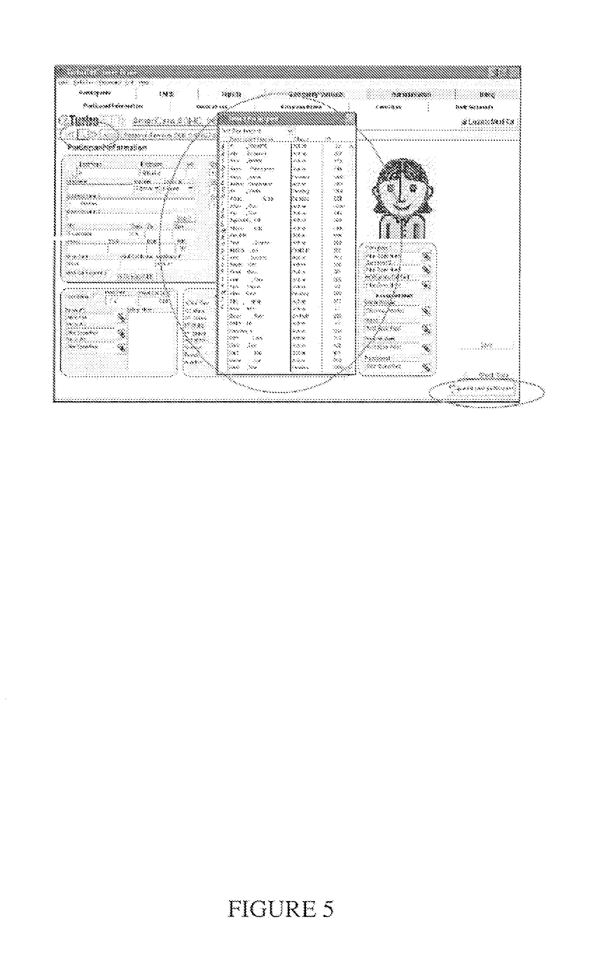

FIG. 5 illustrates a screenshot that may be used to select a participant. As shown, a participant may be selected by a list in a pop-up window. Alternatively, the window may be configured in a region of the user interface. In another embodiment, a participant may be selected by completing one or more fields of the PIS.

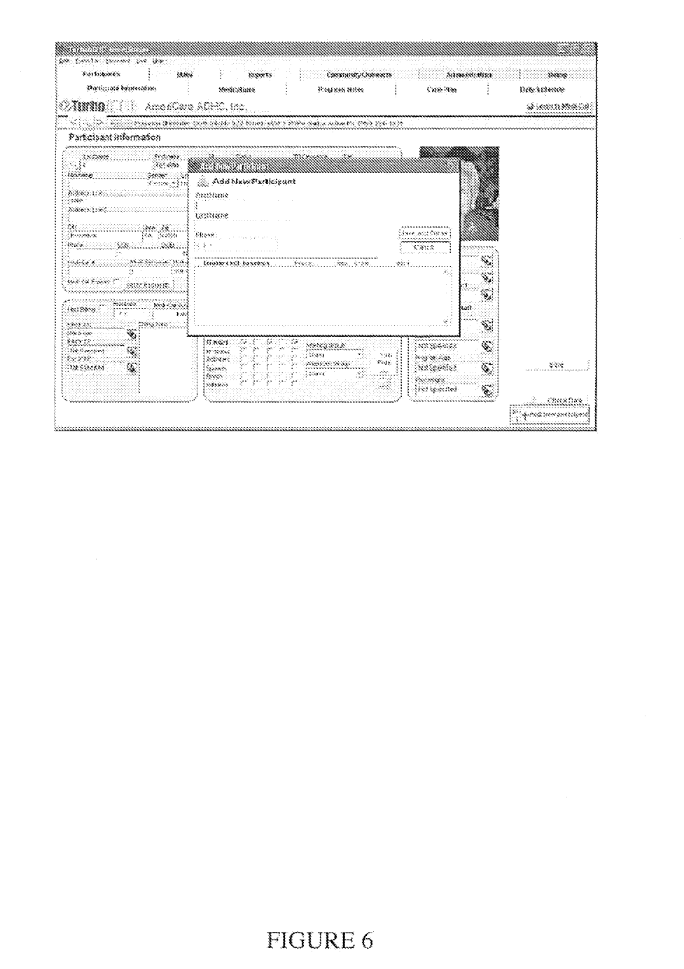

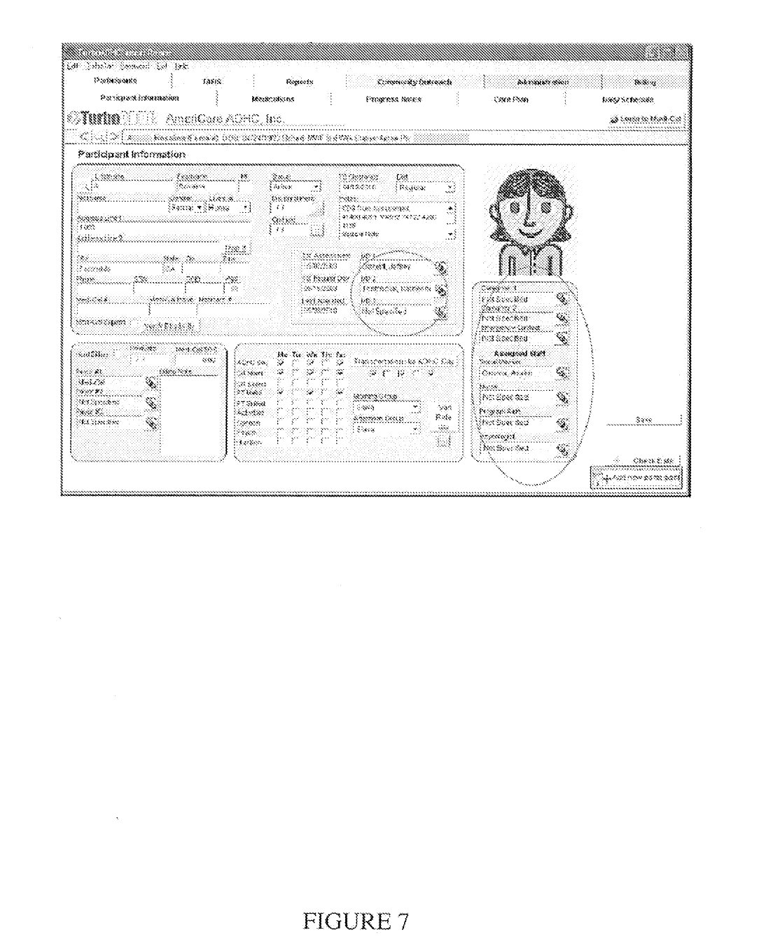

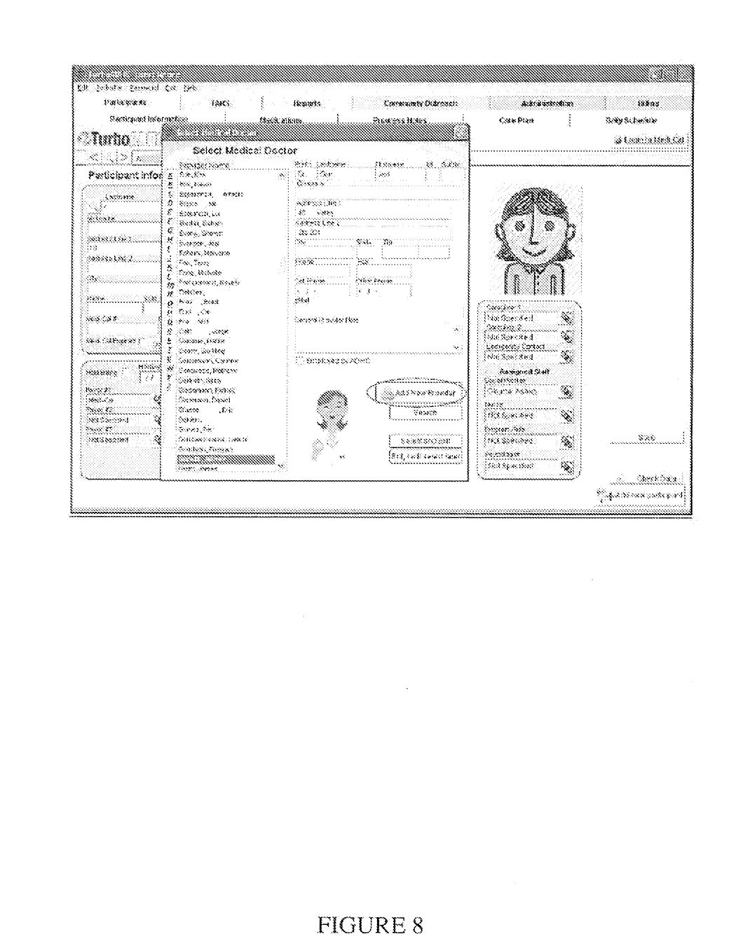

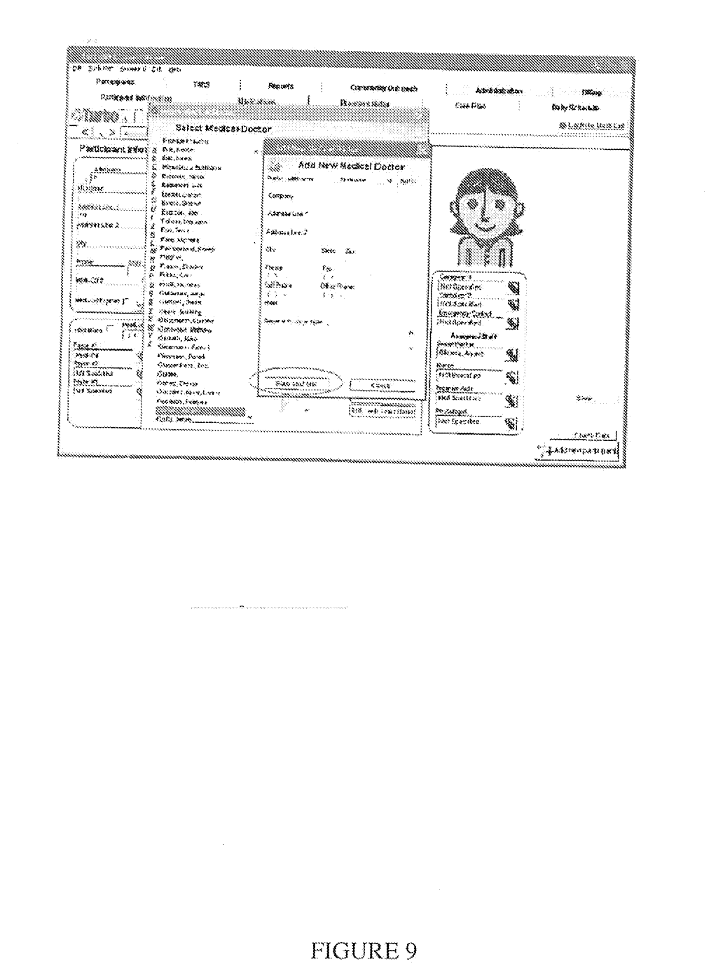

FIG. 6 illustrates a window that may be used to add a participant into the system. The window may be a pop-up window or configured as part of one of the regions of the user interface. A participant's information may be entered in manually or using an automated process. In one example, the participant information may be uploaded from another resource and populate one or more of the fields. In other embodiments, physician, social worker, or other information may be entered into the system using the flow of FIG. 6. As shown in FIGS. 7-8, medical providers and/or other types of healthcare providers may be selected from a list of providers configured in the system.

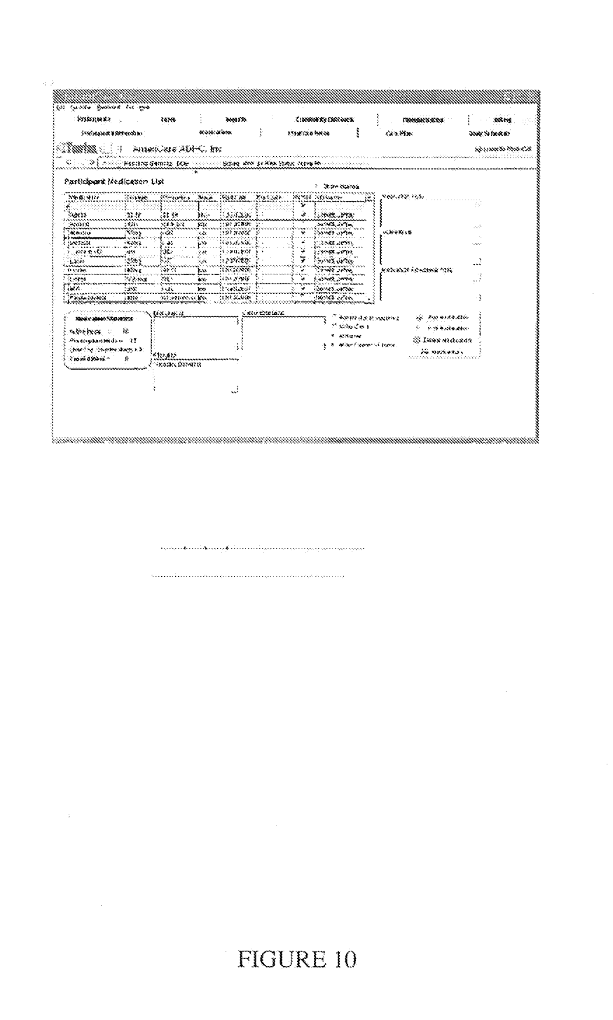

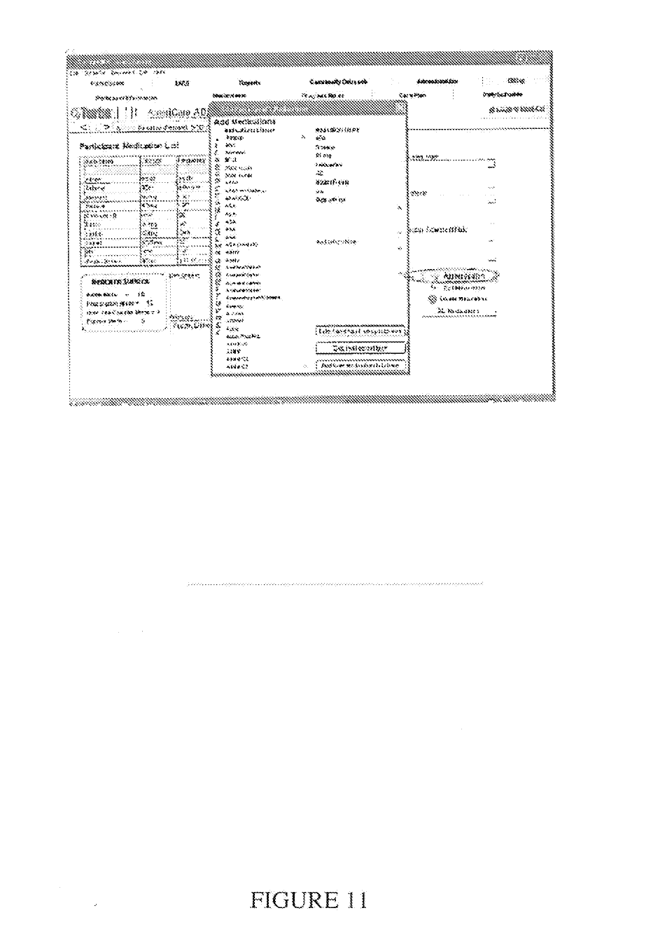

FIGS. 10-15 illustrate an example of a workflow for adding, selecting, updating, changing, and/or tracking the medication for a participant. Referring to FIG. 10, the Medication tab may be selected from the user interface, which will display information, such as the participant's medical list, medication statistics, diet information, and allergy information. As shown in FIG. 10, a medication may be listed in a grid and include the medication name, dosage, frequency, mode start date, end date, Rx status, and prescribing physician.

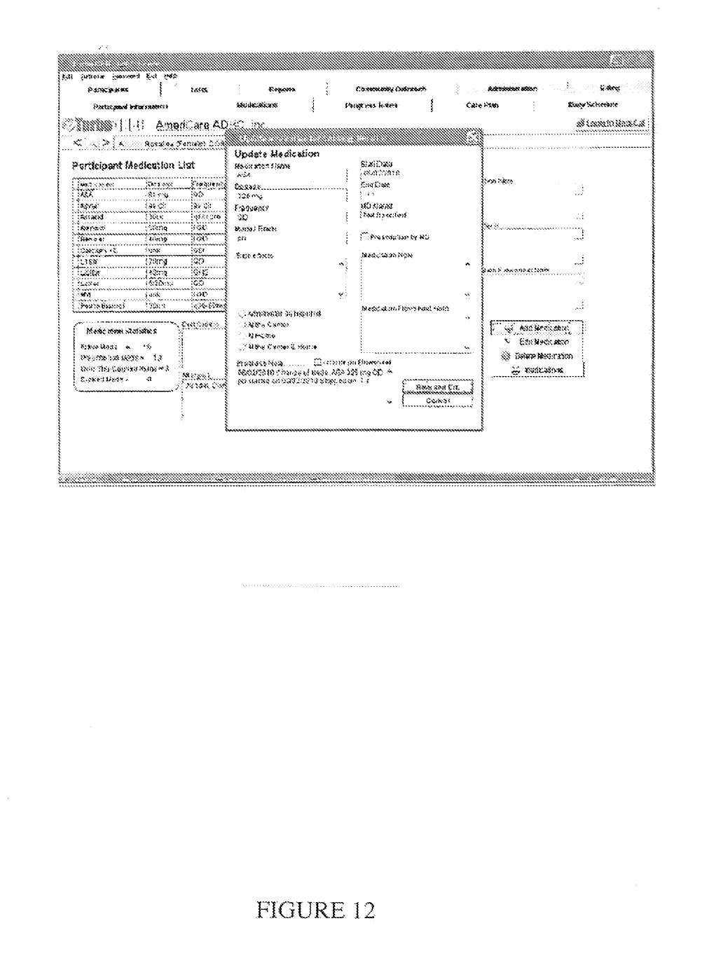

FIG. 11 shows a window that may be used to add a new medication. The medication may be input manually, selected from a list, or uploaded from another source. In one embodiment, when a new medication is added or an existing one is updated or edited, a note box may be generated automatically and added to the progress notes discussed herein, as shown in FIG. 12. The note may also be deleted.

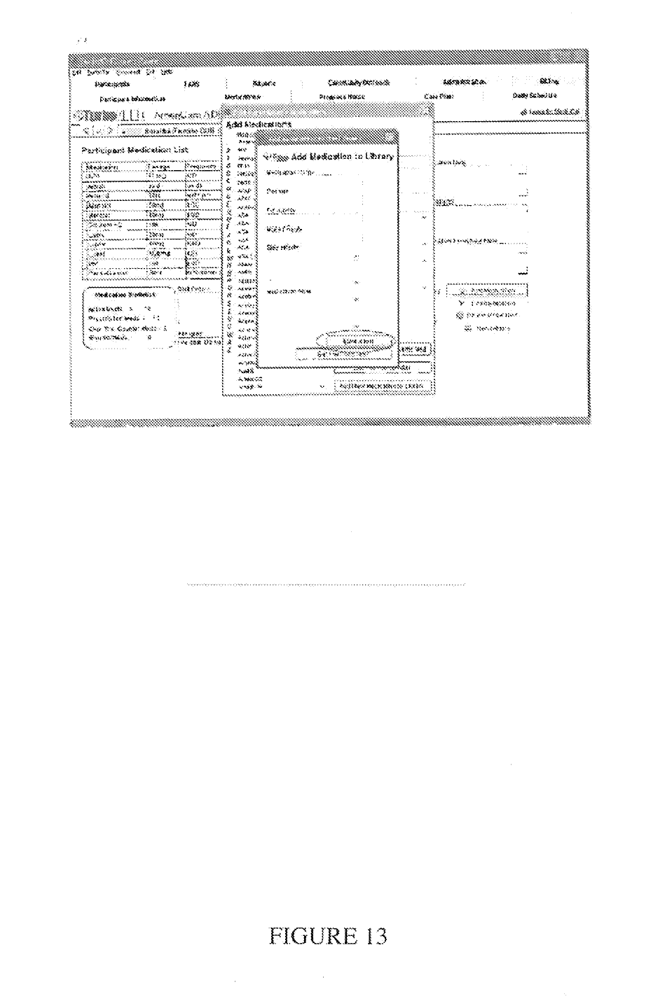

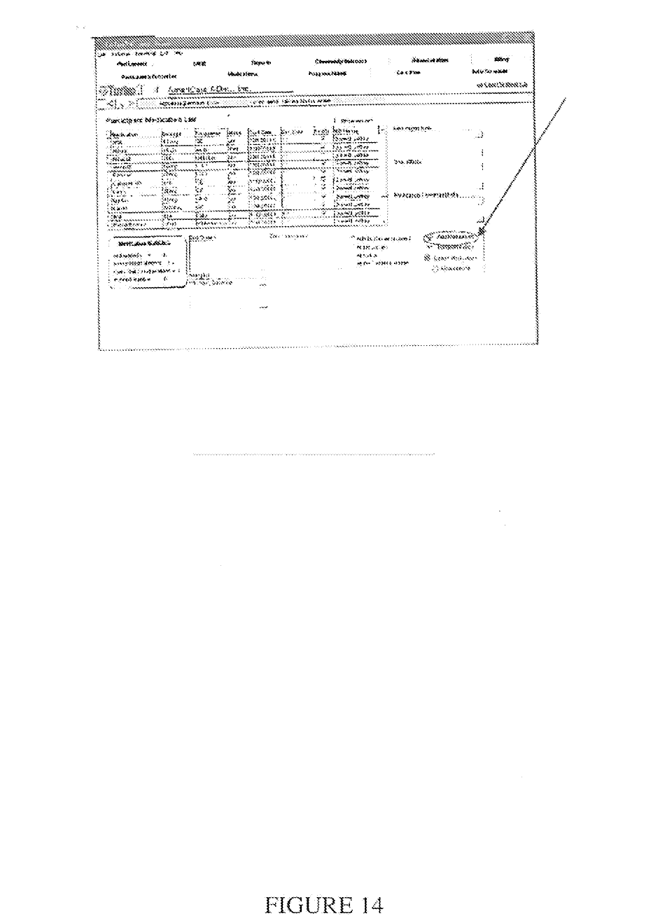

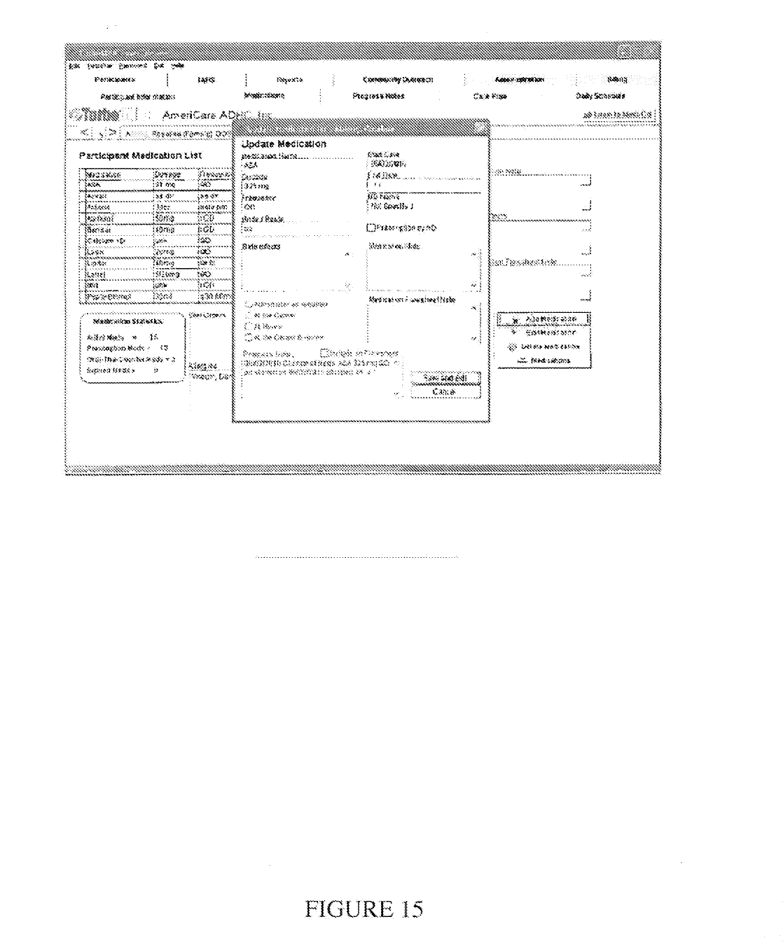

The system may also include a library configured to store one or more medications. The library may be a self-learning library. FIG. 13 illustrates a screenshot including a window for adding a medication. The medication may be added manually, selected from a list, or uploaded from another source. FIGS. 14 and 15 show screenshots for updating or editing a medication. A note box mandated to reflect any change as discussed above. The information about the medication may be input manually, selected from a list, or uploaded from another source.

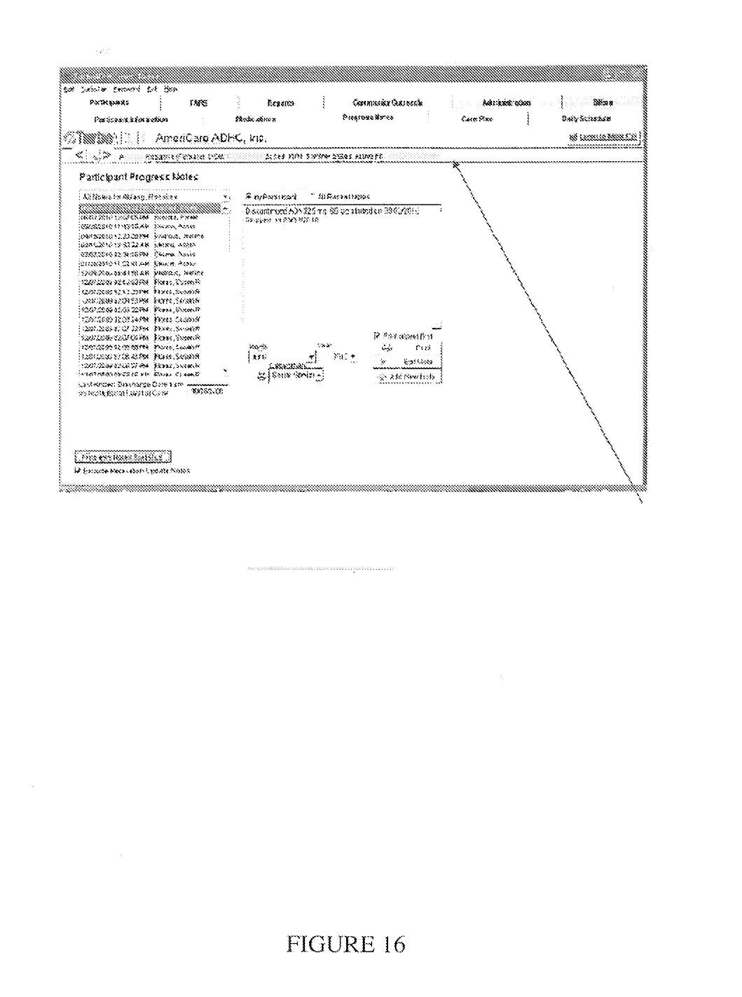

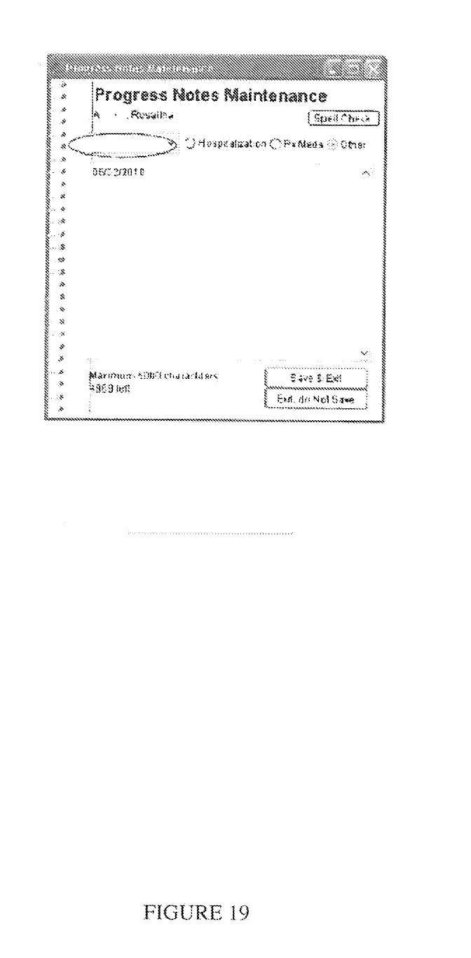

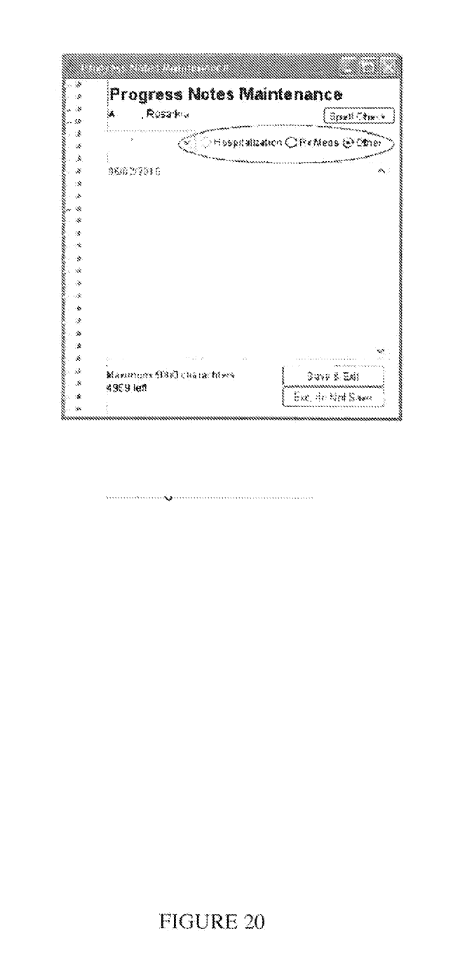

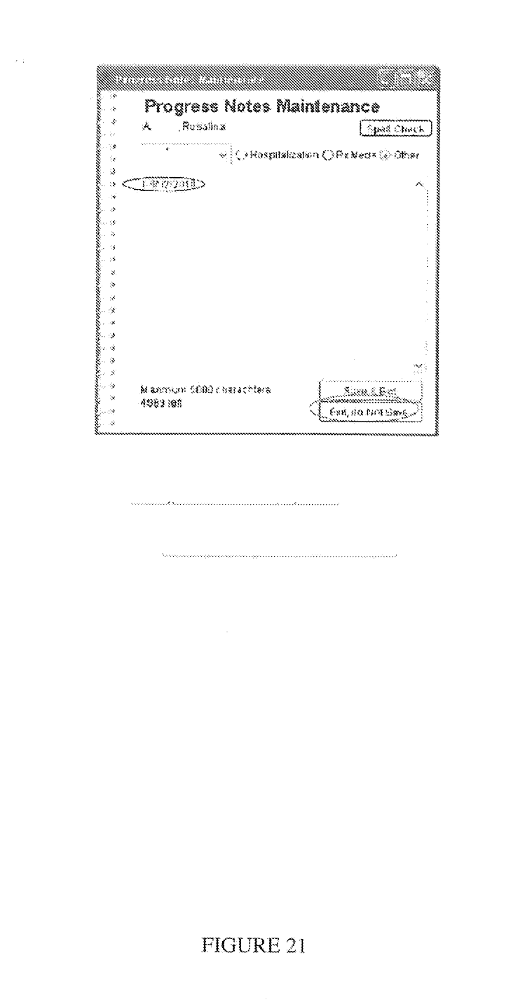

FIGS. 16-26 illustrate example screenshots of a PNS in accordance with various embodiments. FIG. 16 shows a view of the user interface with the Progress Notes tab selected. As shown, the interface may include several regions for listing different progress notes for a participant, an area to view and/or edit the notes, various functions including printing editing, electronic signatures, and adding new notes.

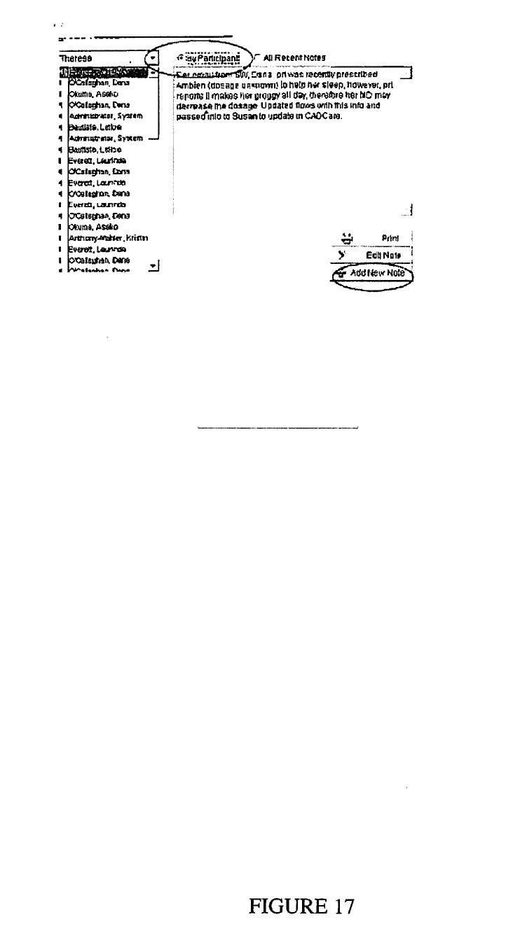

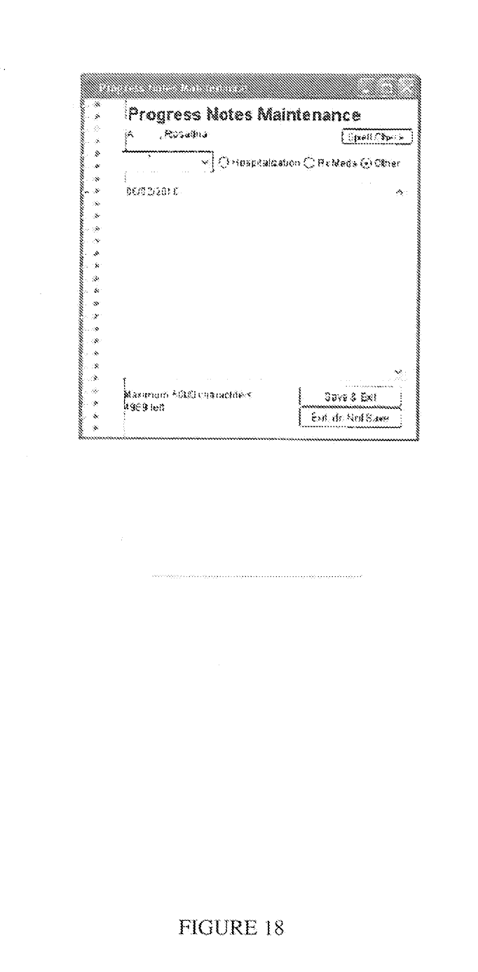

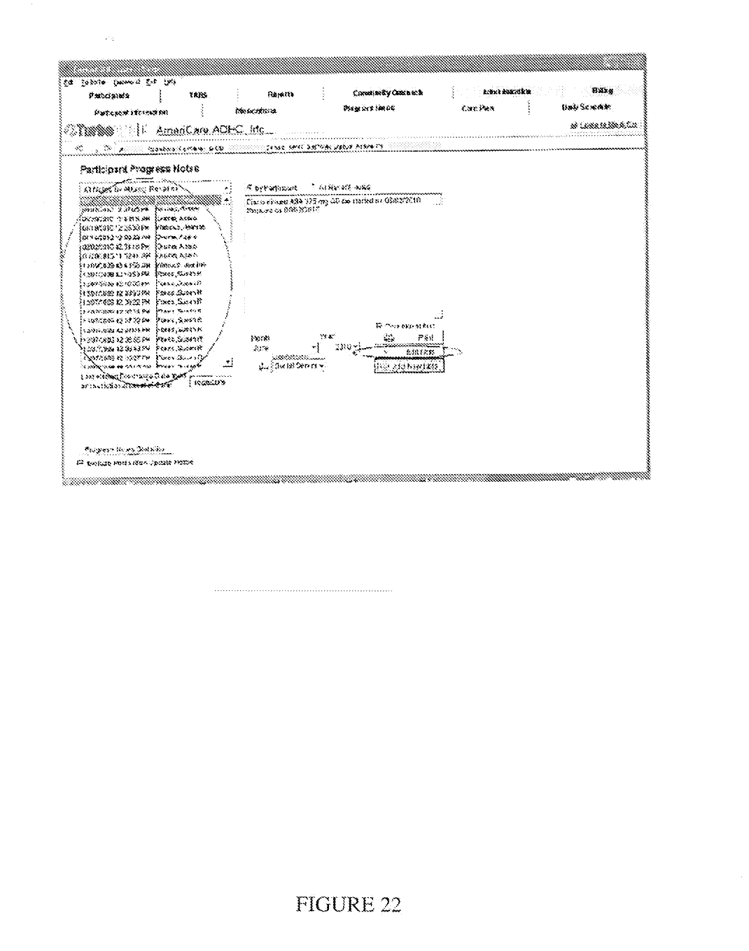

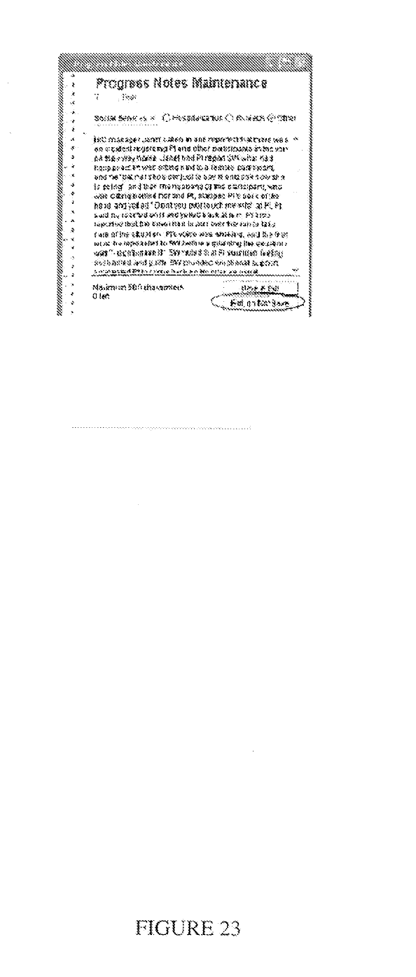

Referring to FIG. 17, a participant may be selected by activating a radio button, To add a new note, the “add New Note” button may be selected. FIGS. 18-21 illustrate a window for adding progress notes. The workflow may include selecting which department a note belongs to and then noting a category for the note. The note may be populated manually and/or automatically. As shown in FIGS. 22-23, a note may be edited by selecting the “Edit Note” button. The system may also include a variety features to enable printing in a variety of formats including those compliant with government regulations.

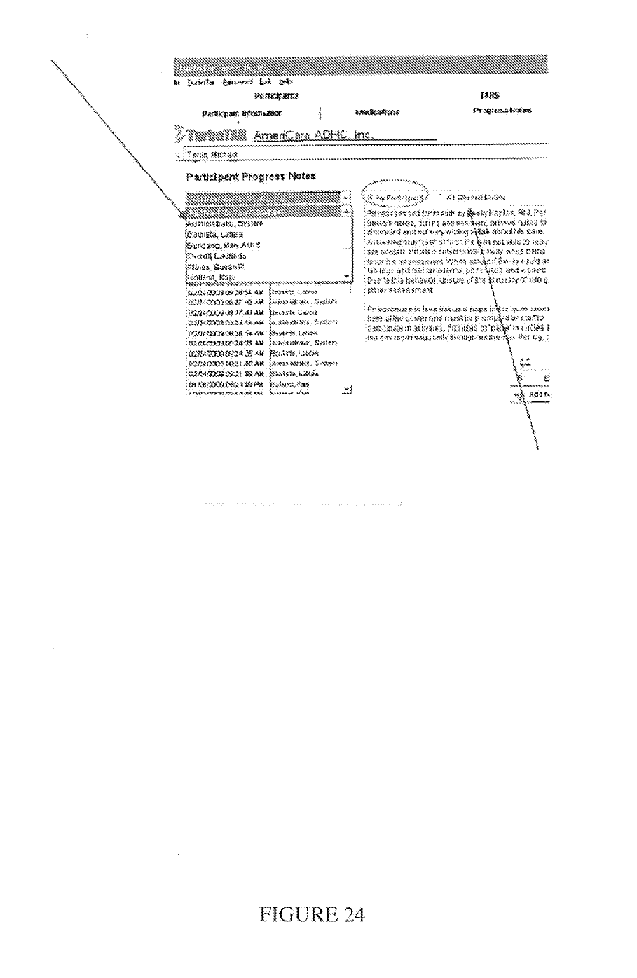

FIG. 24 shows an example of how notes may be sorted. In one embodiment, the progress notes may be sort by participant. In another embodiment, the notes may be sorted by author selected from a drop down menu. In yet another embodiment, the most recent notes may be selected by choosing the “All Recent Notes” button.

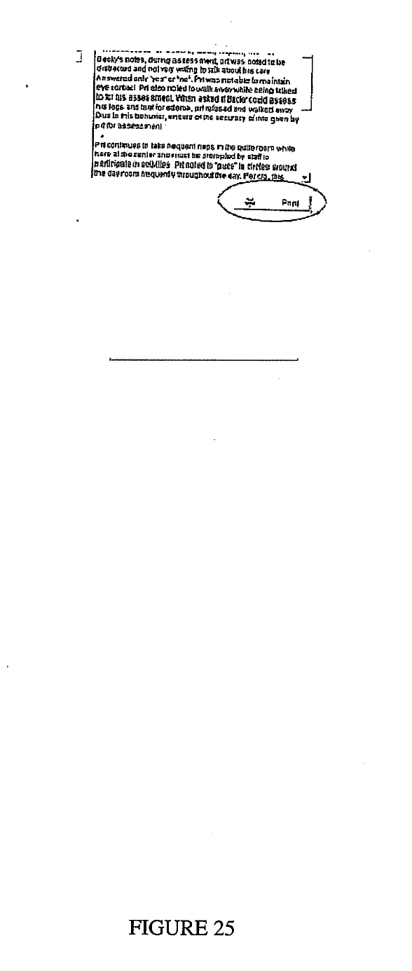

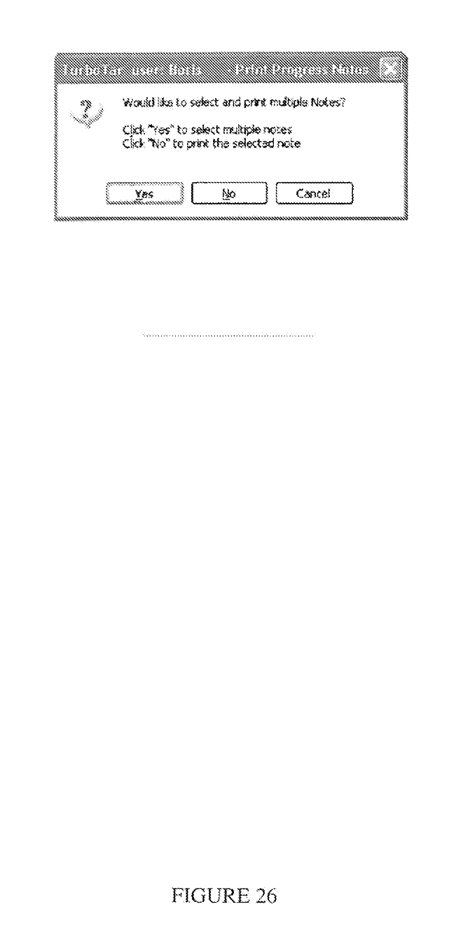

FIGS. 25-26 illustrate how a note may be printed. As shown, one or more notes may be printed. In one embodiment, a subset of notes may be printed from a list.

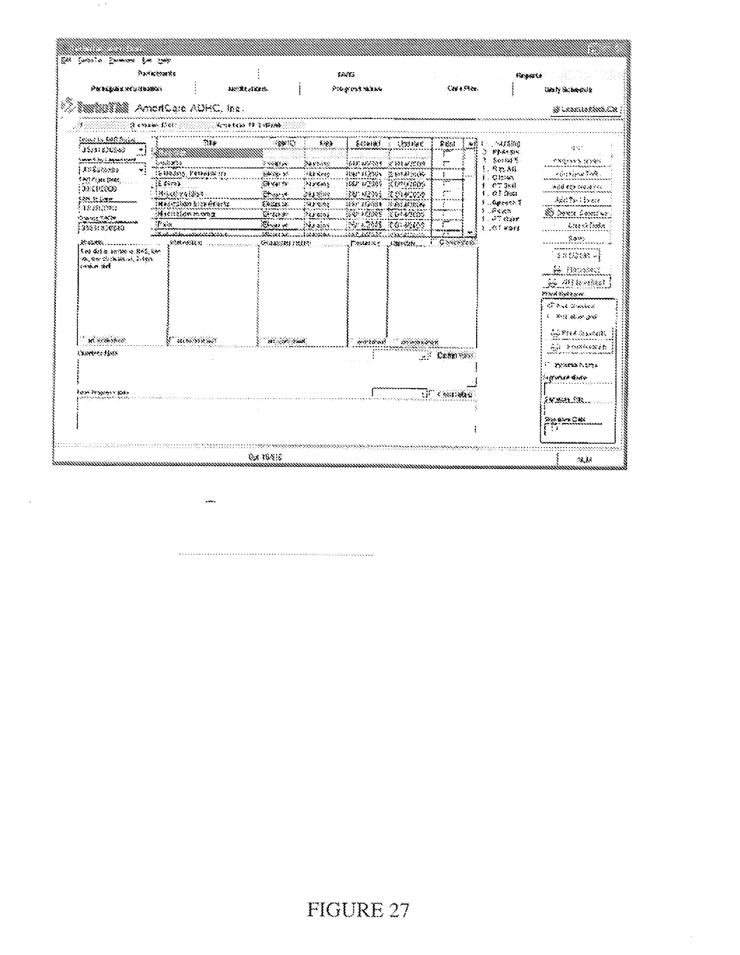

FIG. 27 illustrates an example of a CPS in an embodiment, The CPS may be configured to provide access to various functionality including IPC, progress notes, adding a new TAR, adding a new care plan item, a care plan library, deleting a care plan, flow sheets, quarterly and reauthorization notes, and/or printing. The CPS may be activated by clicking the Care Planning tab.

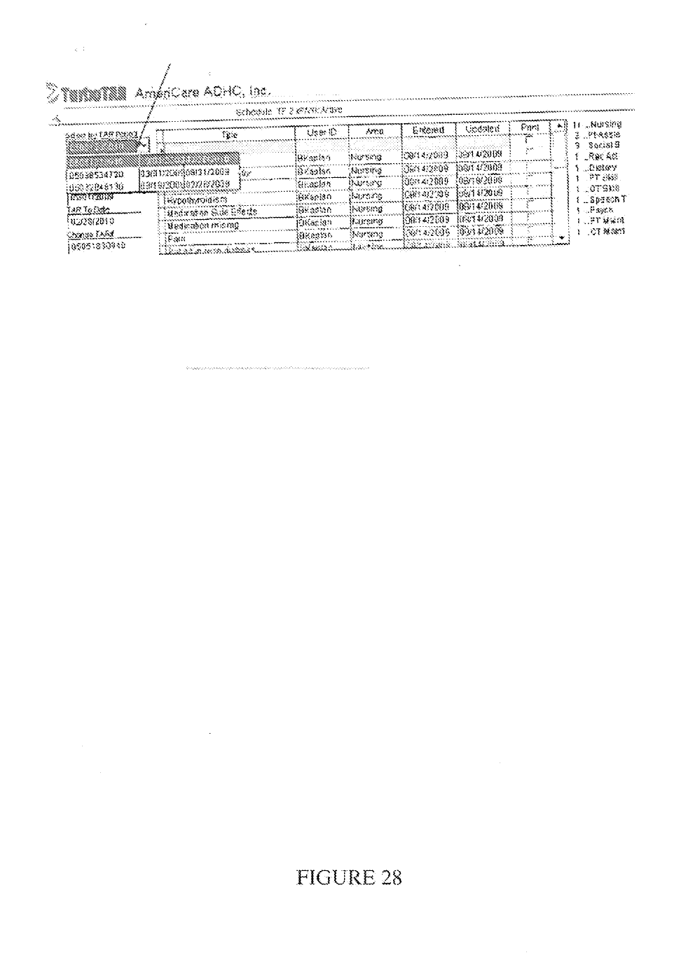

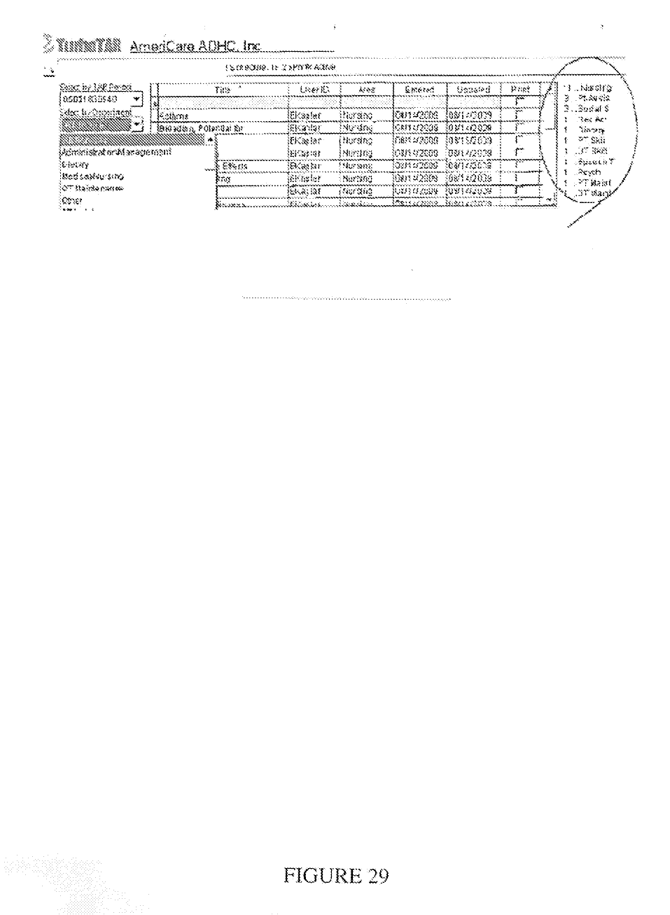

FIG. 28 illustrates a flow for viewing care plans for a specific TAR period or date range. In one embodiment, the care plan may be selected from a drop down menu. FIG. 29 illustrates a flow for selecting a care plan by service type. A variety of service types may be supported by the system. Examples may include nursing and social work. The care plans may be stored in a library. The care plan may be selected based on a number of categories including nursing and social work.

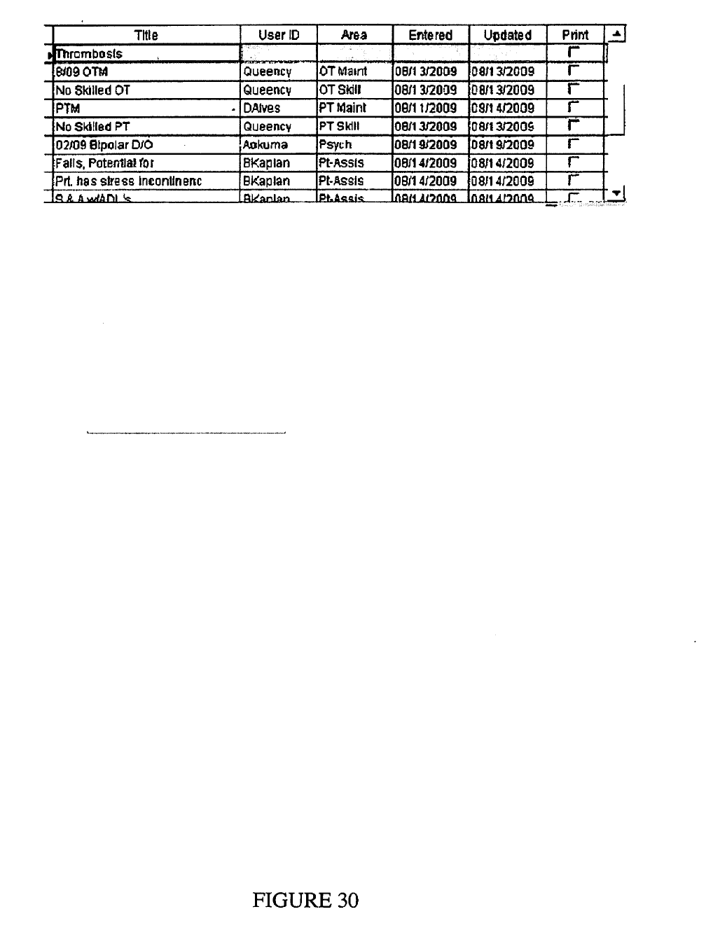

FIG. 30 illustrates a care plan grid in an embodiment. The grid may include the name of the care plan, an associated department, a creation date, and the like. The subject fields may be used to sort the care plans. The grid may track the author of the care plans, author of the care plan, and/or changes made.

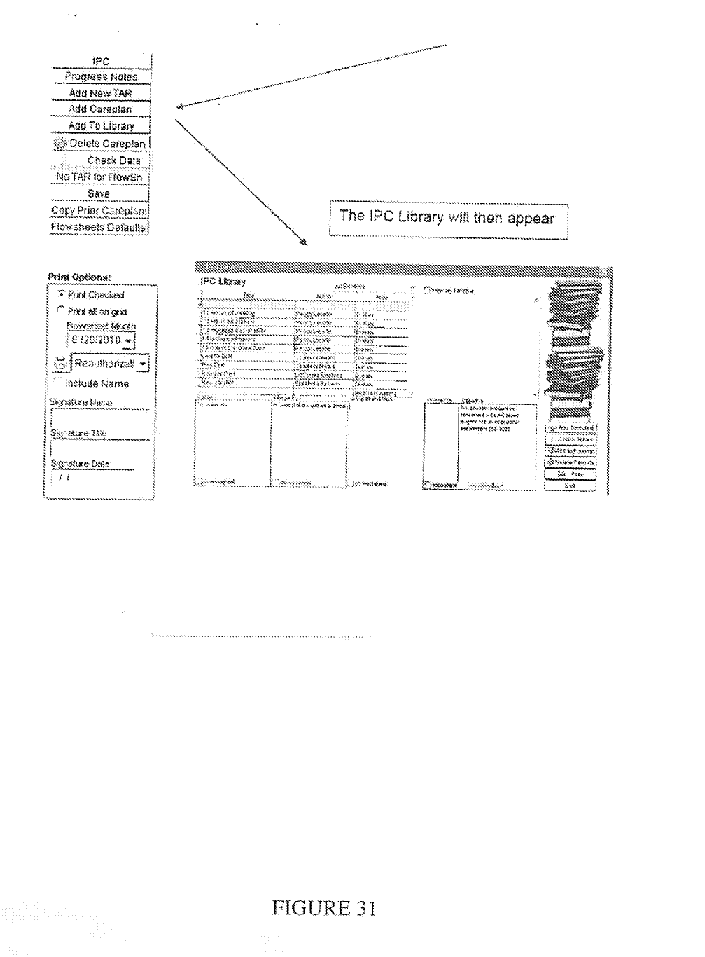

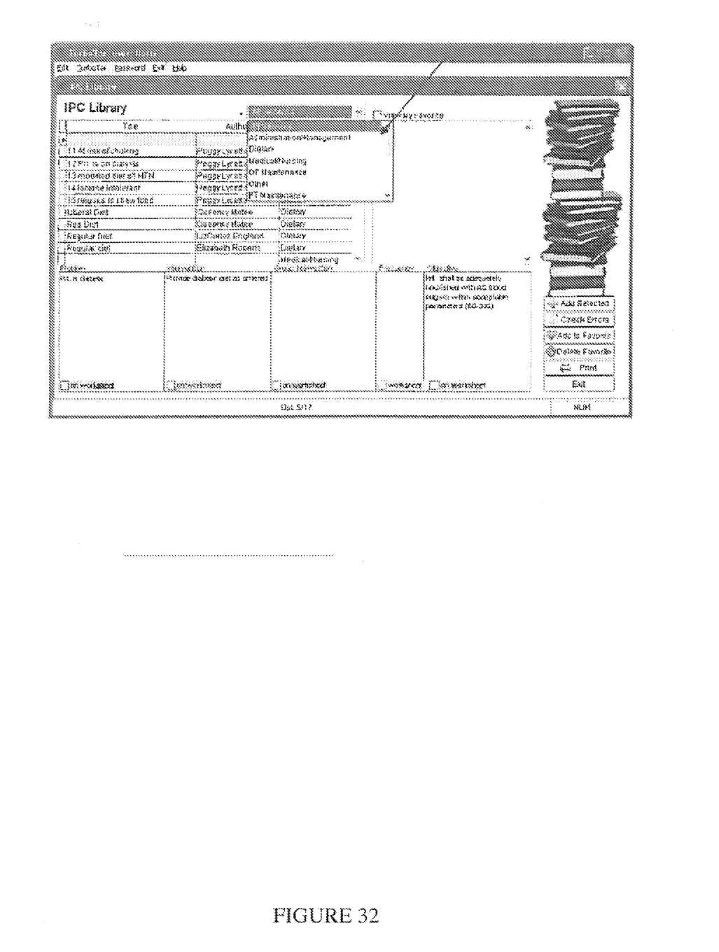

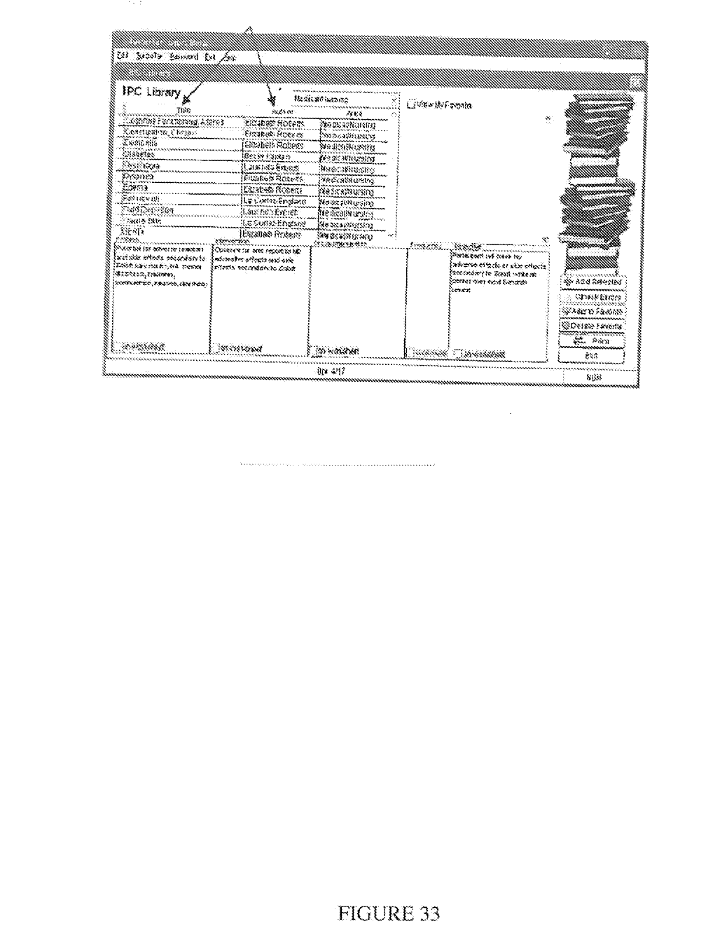

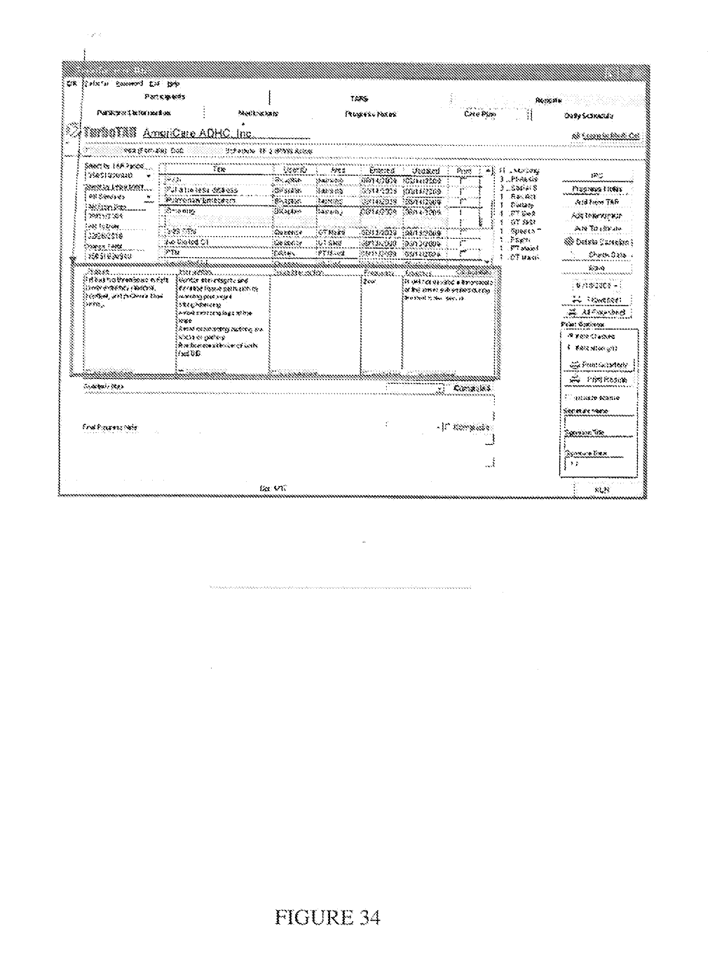

FIG. 31 illustrates a workflow for adding interventions and/or care plan items for a participant. In one embodiment, a TAR period may be selected for the care plan item. In one embodiment, an entry may be added by selecting the “Add Intervention” button. The system may be configured with an IPC library that provides one or more templates for developing a care plan. FIGS. 32 and 33 show a workflow for creating a care plan using the IPC library. FIG. 34 illustrates a screenshot of a care plan that includes one or more fields that may be used to customize a care plan. In addition, a care plan may be saved to the library.

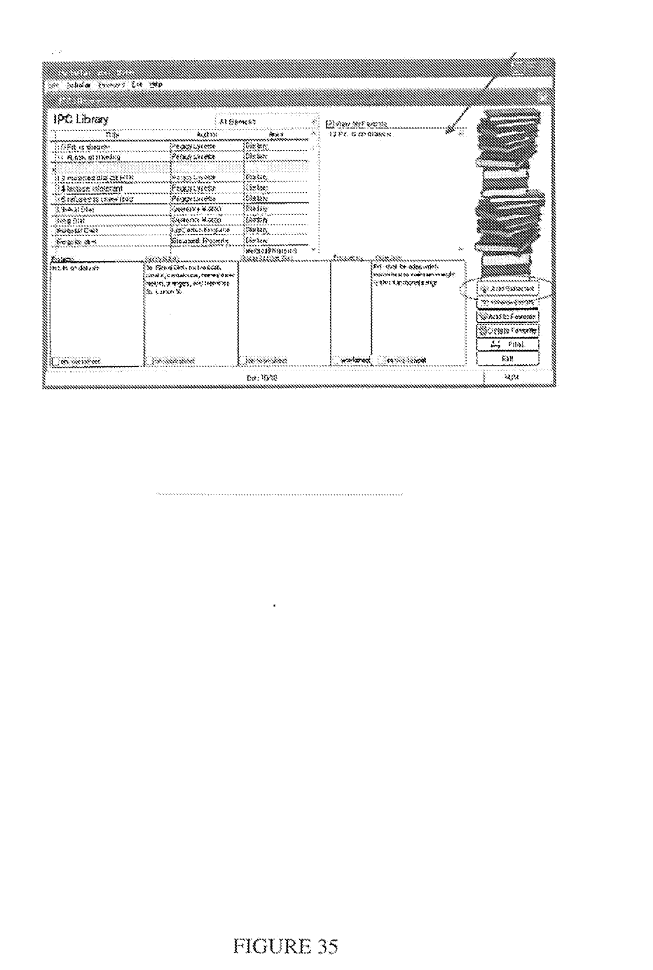

FIG. 35 illustrates a screenshot that may be configured to add a care plan to a favorites list. When selected, the care plan may be added to the library.

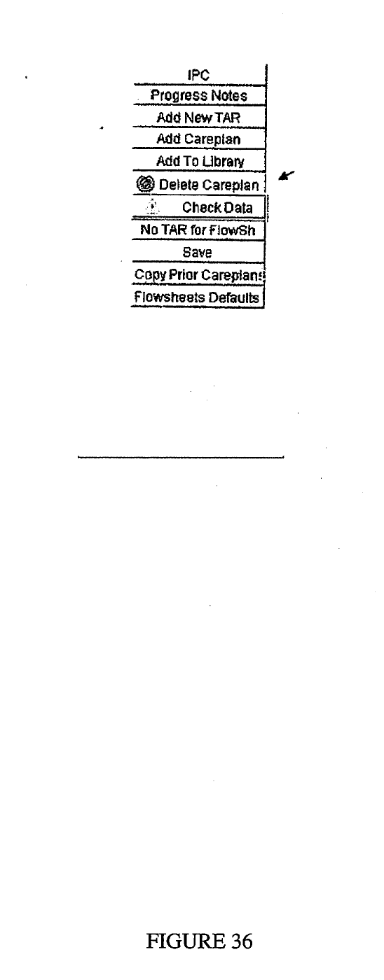

FIG. 36 illustrates a screenshot that may be used to delete a care plan. A plan may be deleted by selecting the appropriate button.

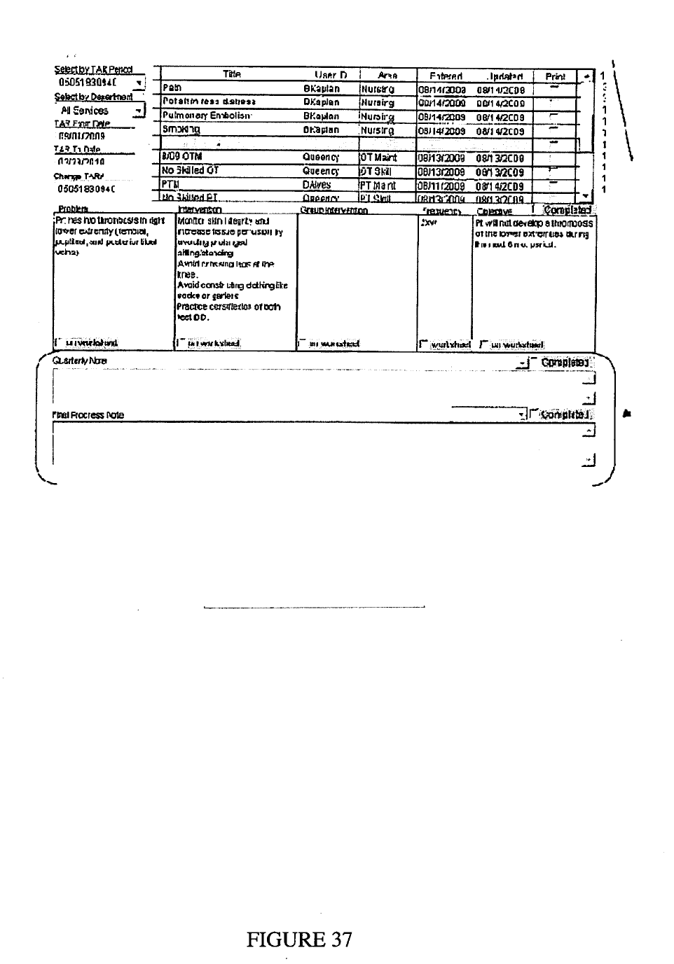

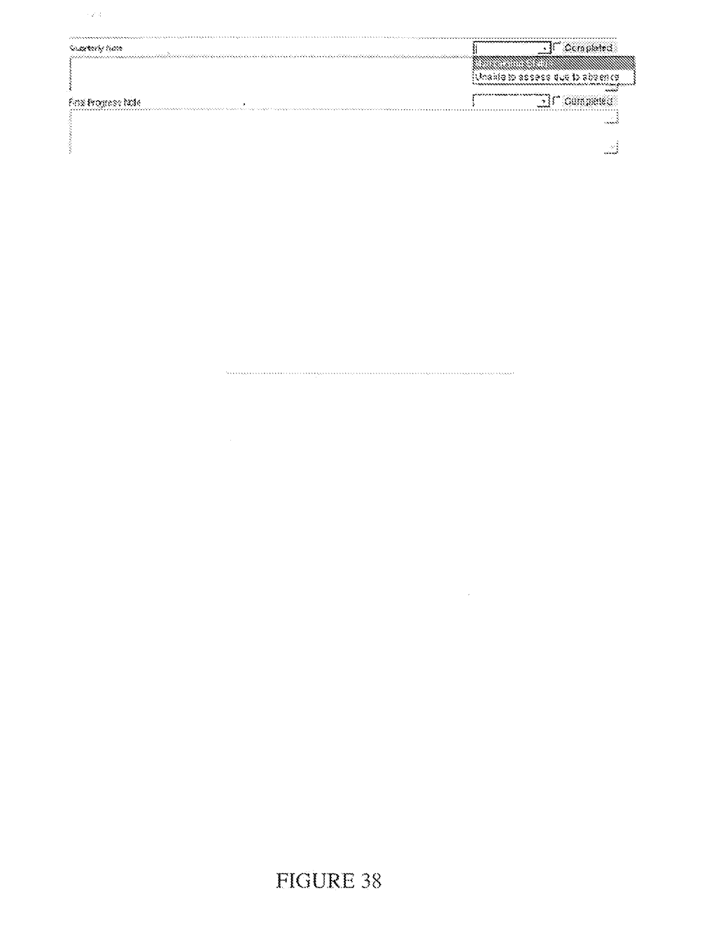

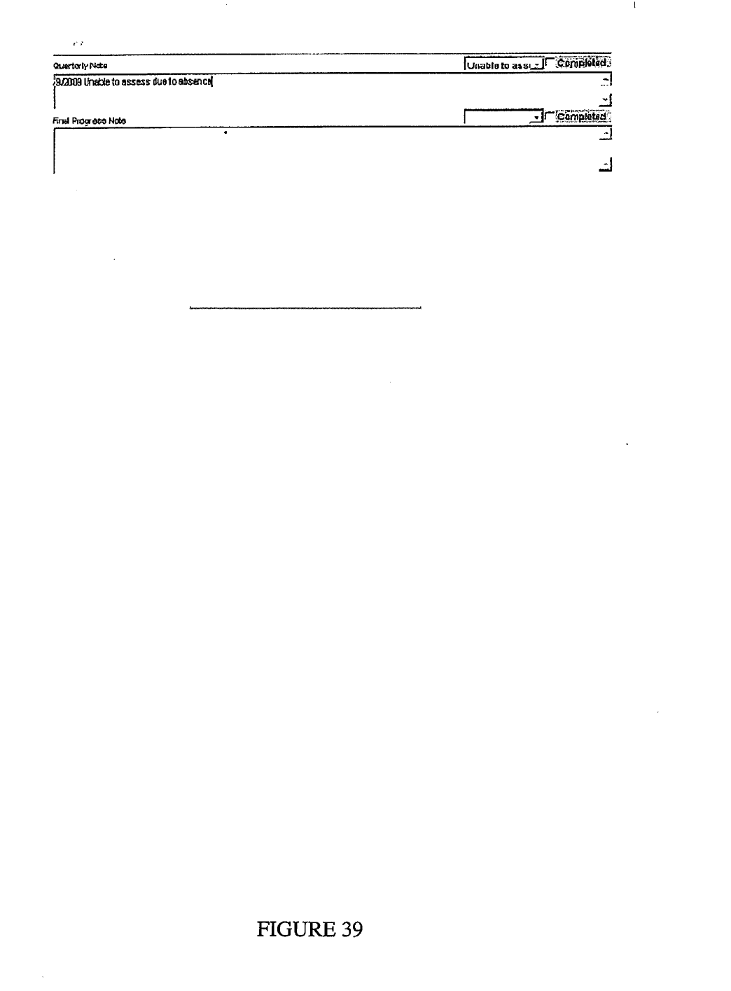

FIGS. 37-39 illustrate a work flow for updating or adding to the progress notes. The notes may be added at any time. As shown in FIGS. 28 and 29, notes may be entered manually or automatically into the fields. In one example, notes may be entered quarterly.

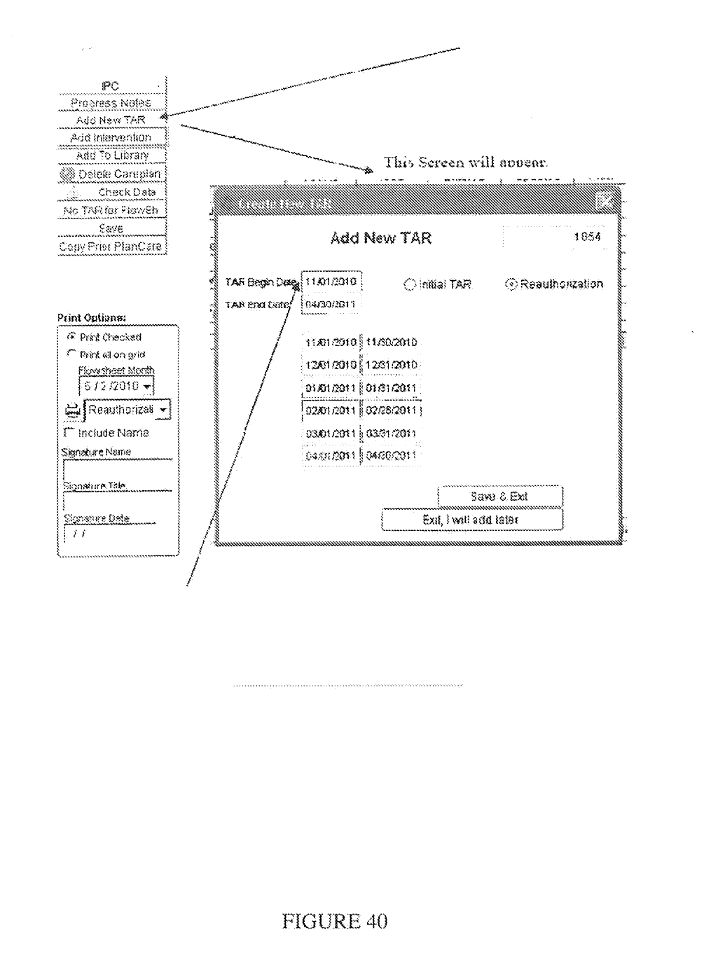

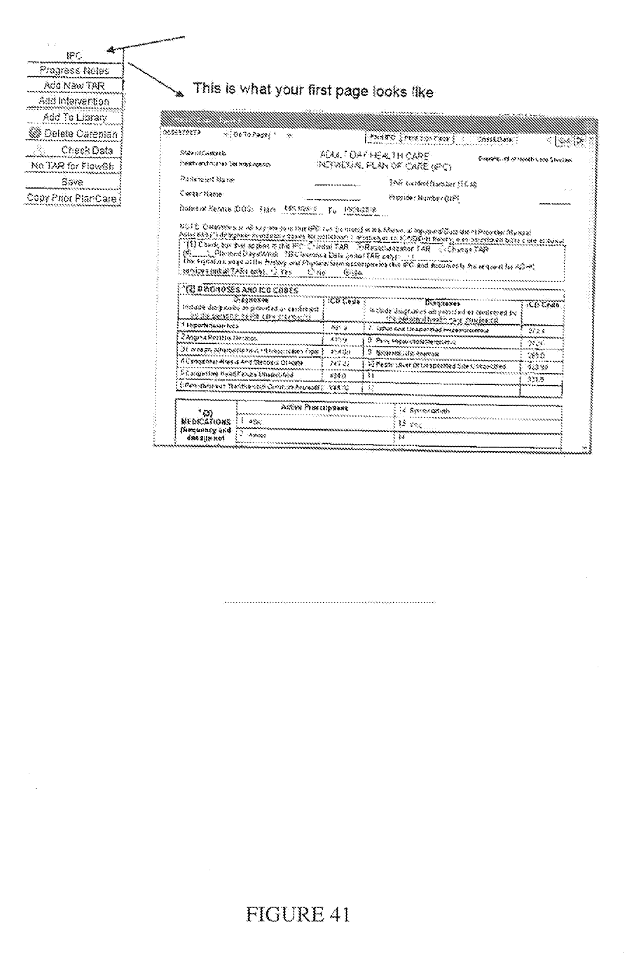

Referring to FIG. 40, a new TAR may be added by activating the “Add New TAR” button, which will cause a window to appear. In one embodiment, opening a new TAR may automatically populate the fields from prior or existing records.

FIG. 4illustrates a workflow for completing an Initial Plan of Care (“IPC”). The IPC may be configured as part of the TAR by activating the TAR tab. The IPC may be activated by selecting “IPC.” The TAR period may be changed by selecting a period from the drop-down menu and manually changing the date. In addition, the system may automatically insert your care plans for the selected participant and the selected TAR period into your IPC.

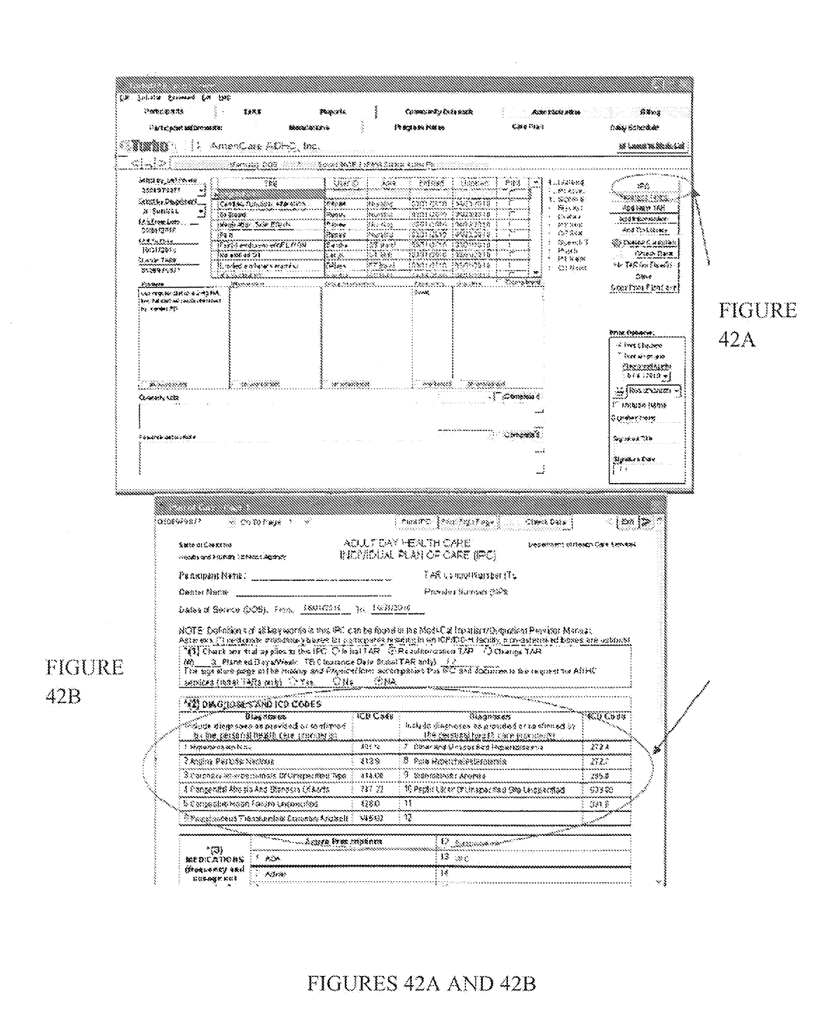

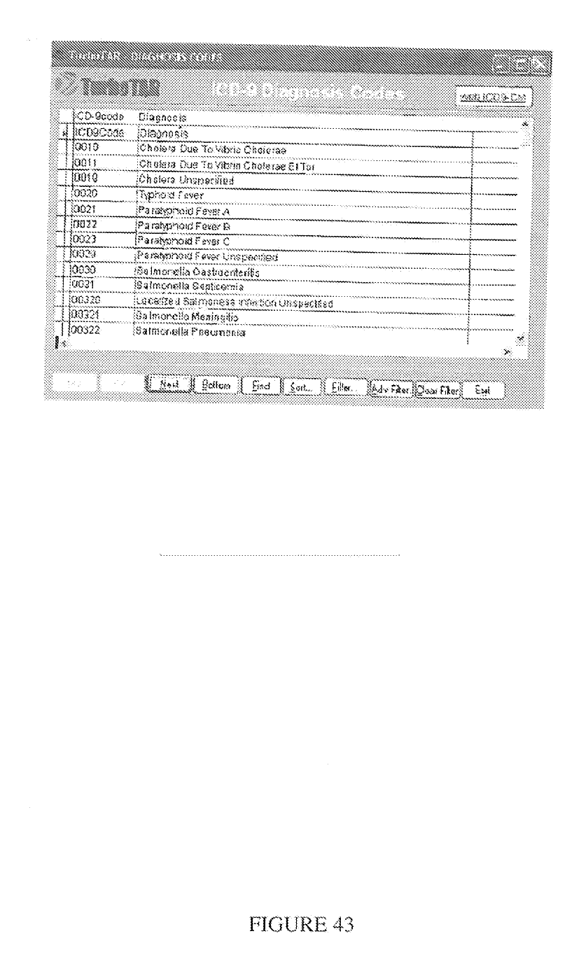

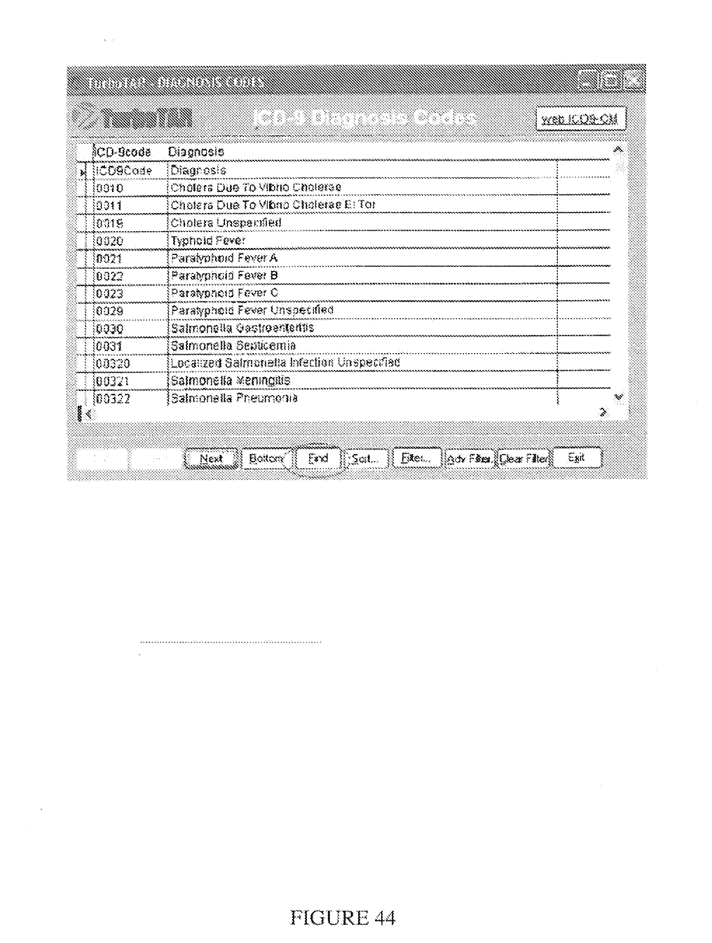

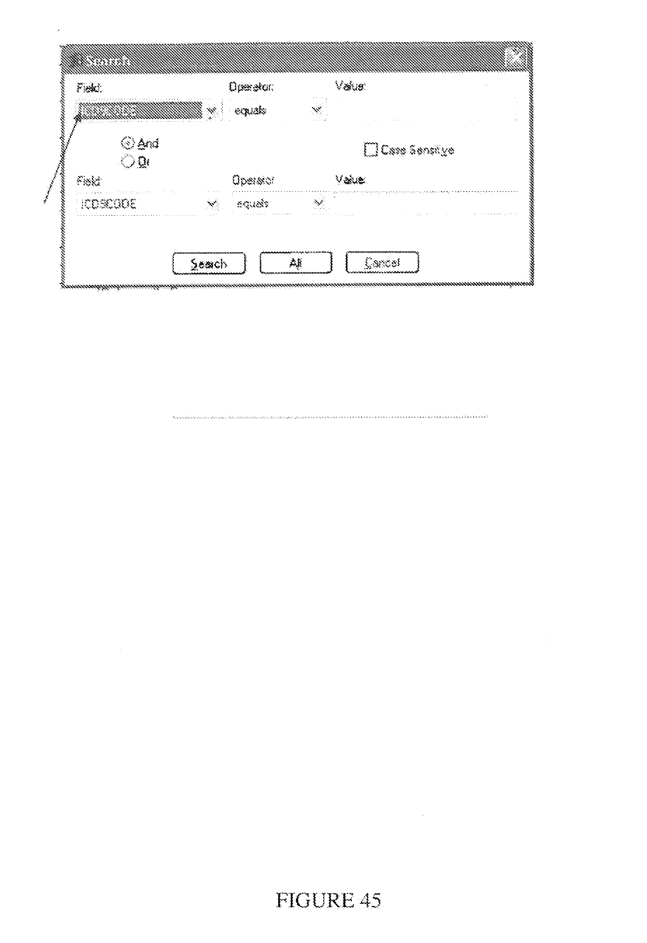

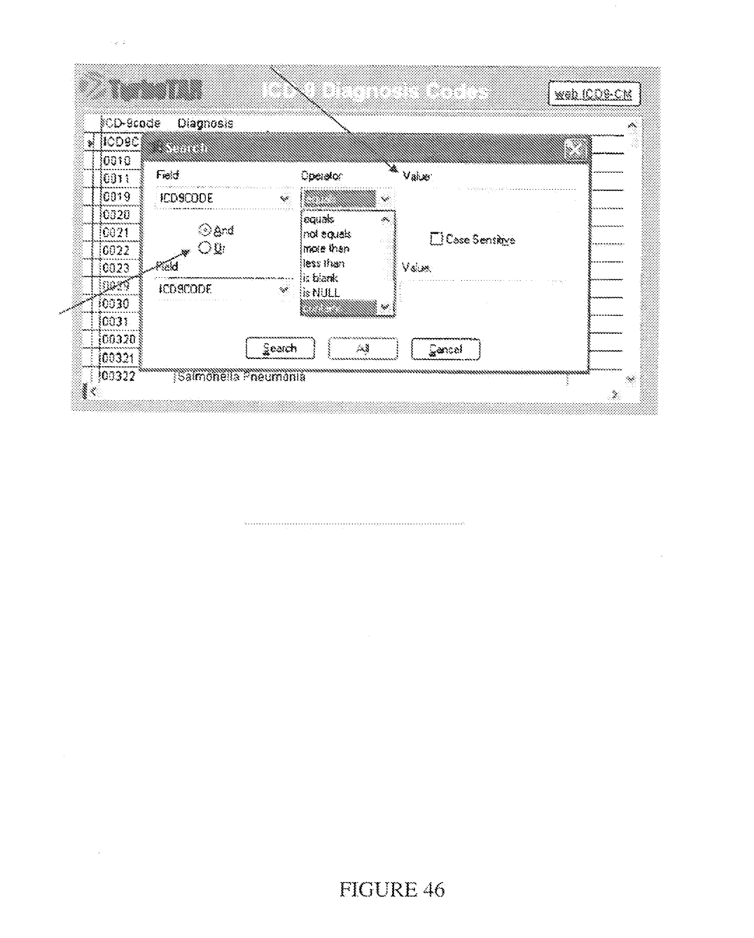

FIGS. 42A-42B show example screenshots in which a diagnosis about a participant may be added or updated. A diagnosis code may be entered in the corresponding box manually or from a directory of codes.

FIGS. 43-46 show a workflow for searching for government codes, such as ICD-9 codes. The system may be configured with codes or codes may be added to the system. The codes may be searched by the codes themselves, name or diagnosis. A search may be conducted by activating the “Search” button.

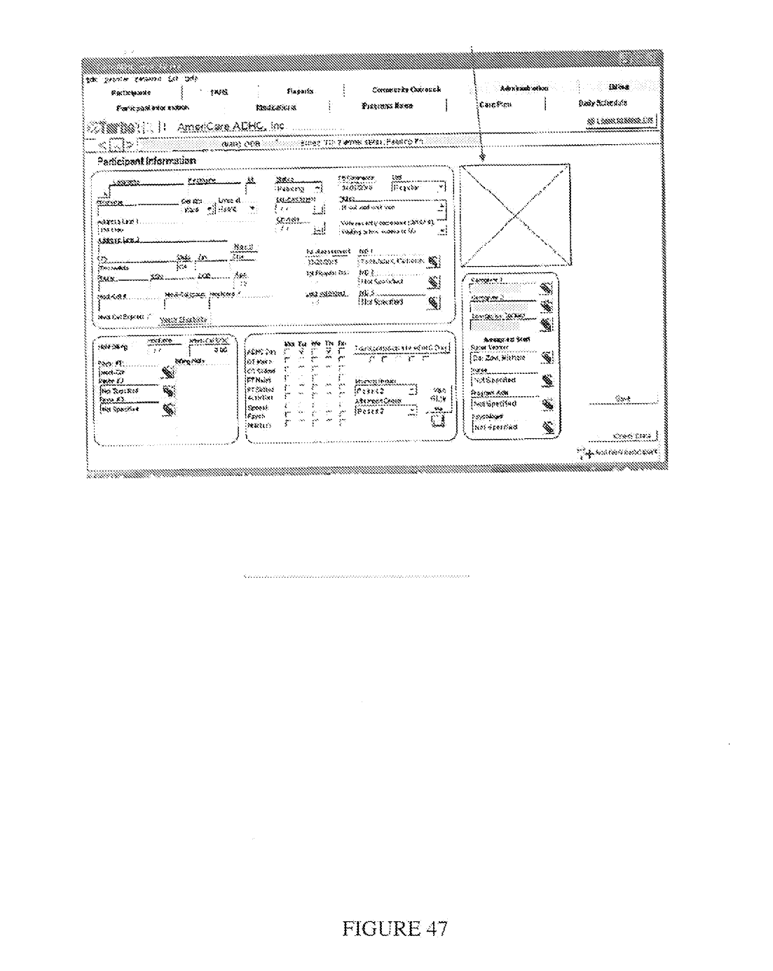

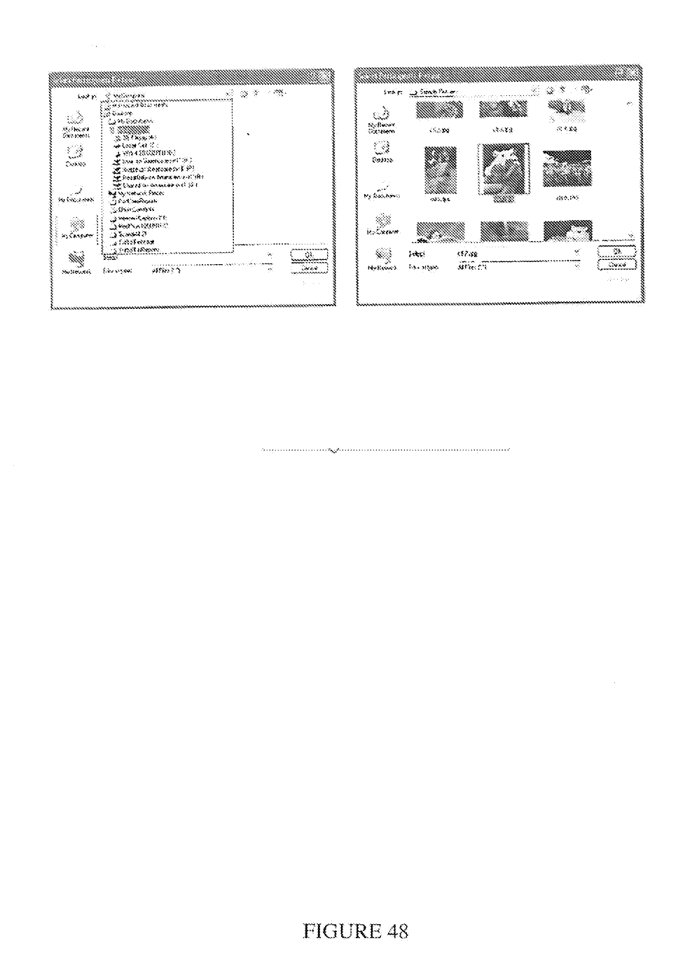

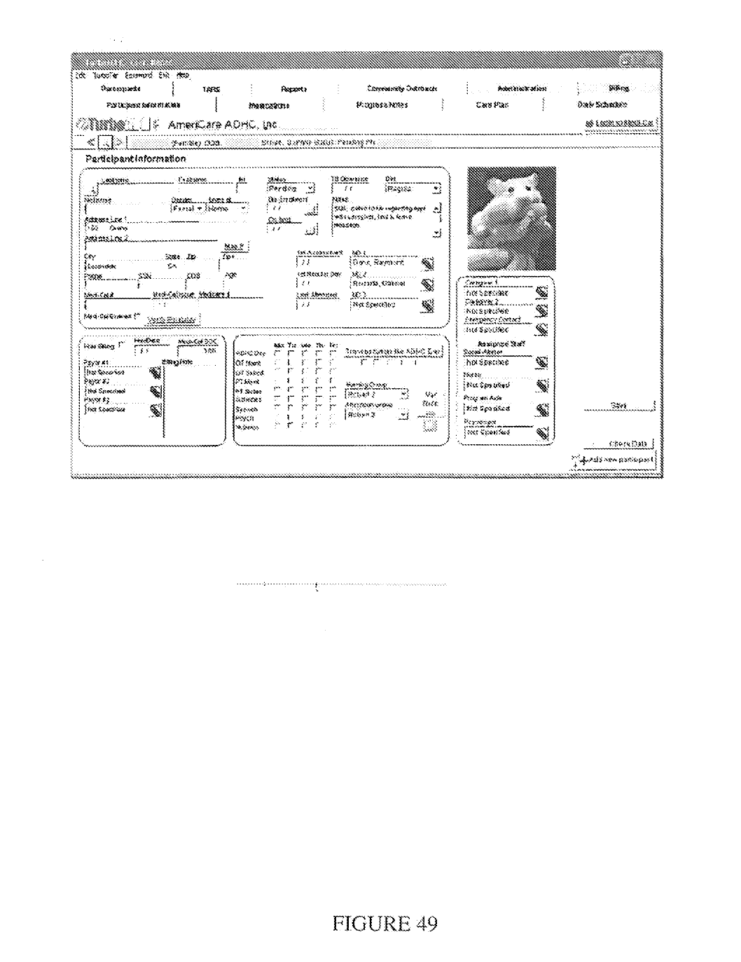

FIGS. 47-49 show a workflow for adding a picture of a participant to the system. The picture may be added manually and/or uploaded from and external source, such as mobile phone, camera, and similar devices

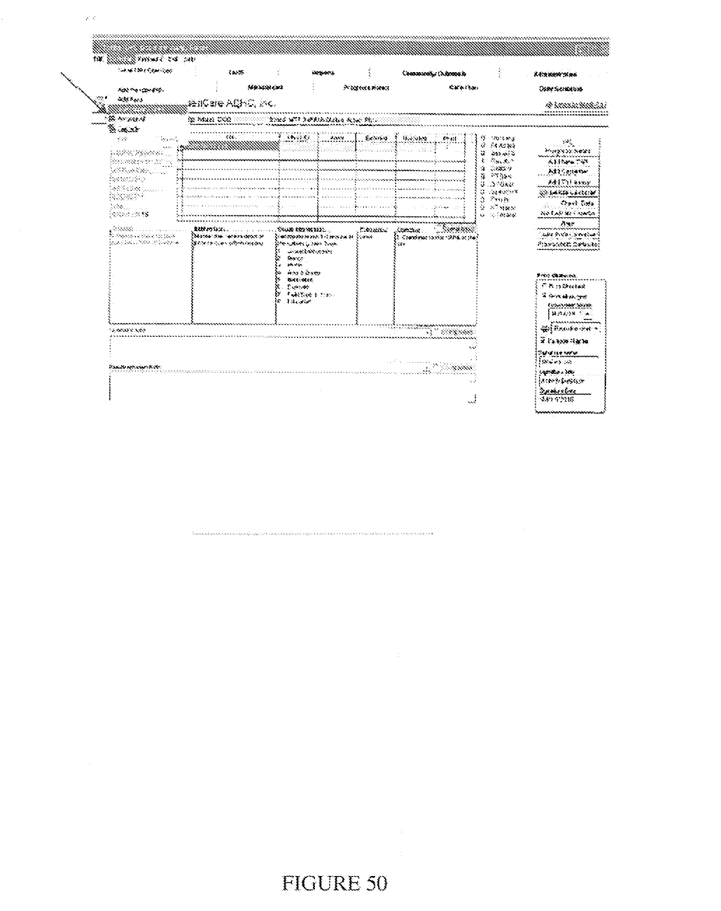

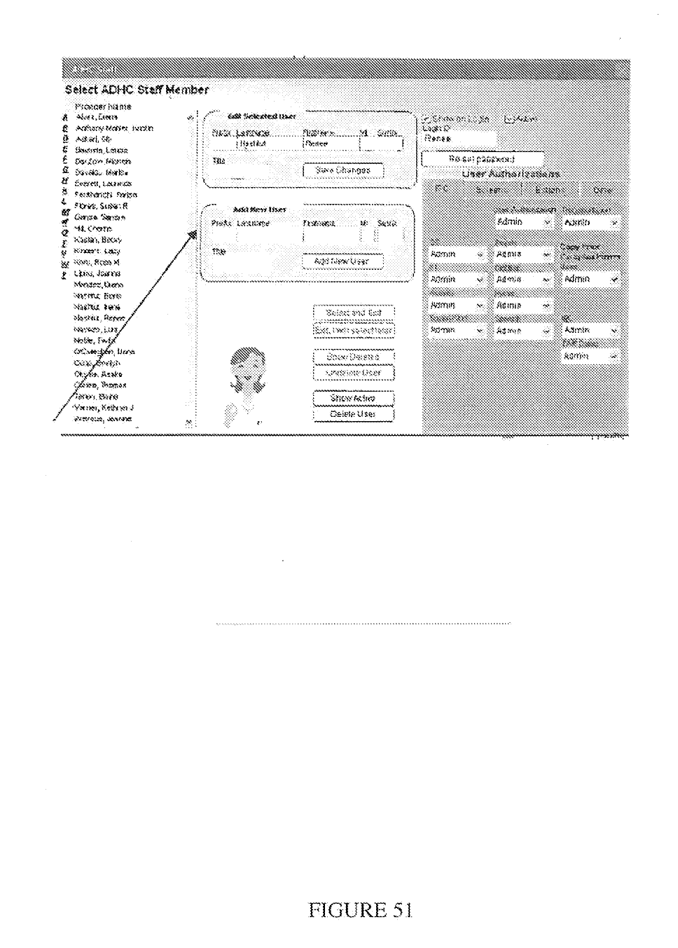

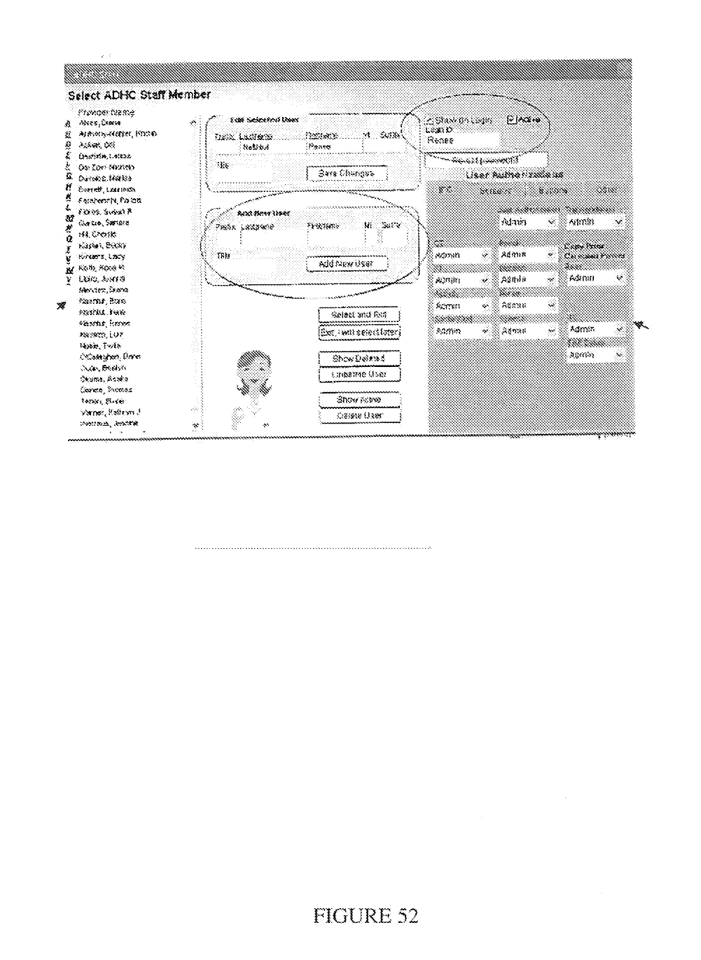

FIGS. 50-52 illustrate a workflow to add a new user to the system. As shown in FIG. 51, a new user may be added. The information associated by a new user may be added manually or automatically.

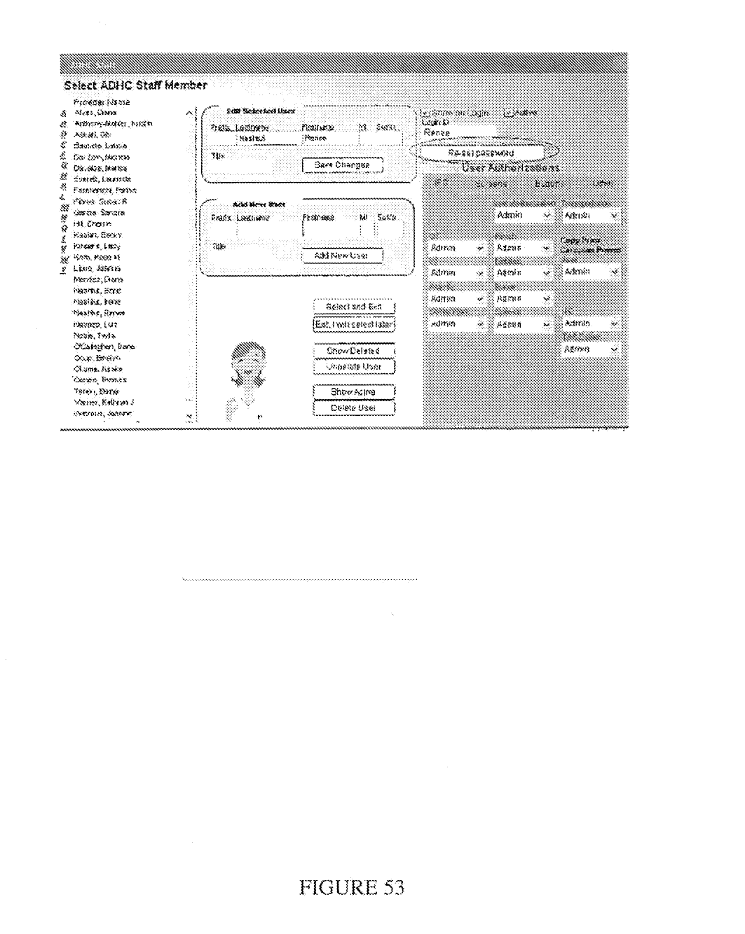

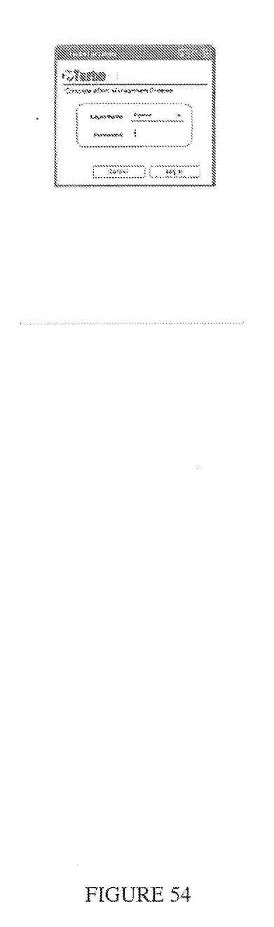

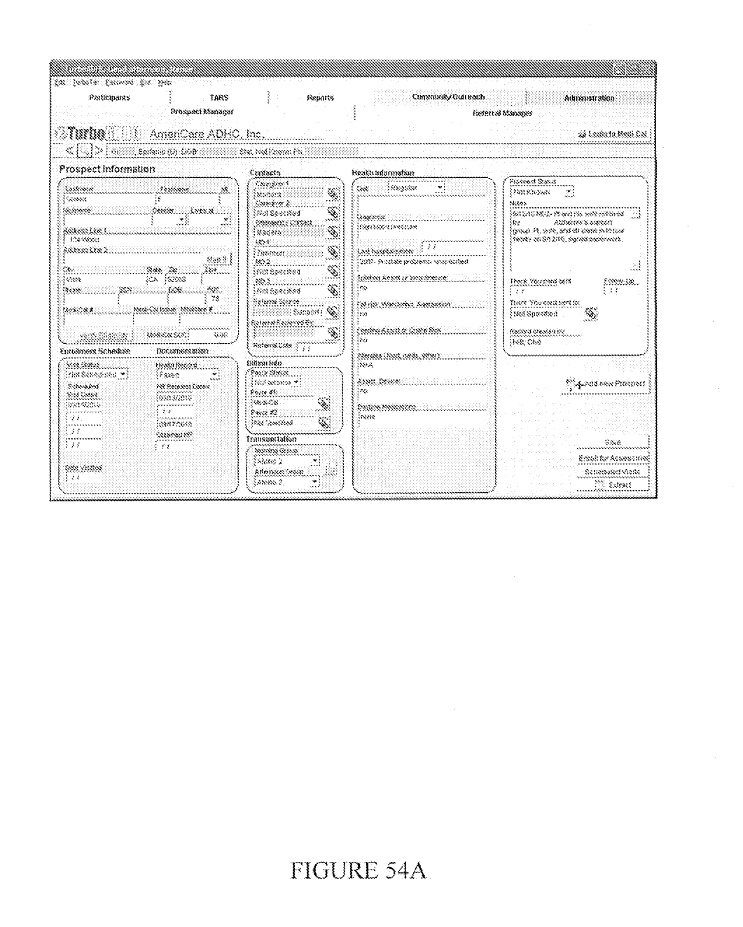

FIGS. 53-54 illustrate a workflow for resetting a user's password. A user may select any name and password that is suitable and recognizable by the system. Once the button to reset password is selected in FIG. 53, a new login and password may be selected by user in FIG. 54.

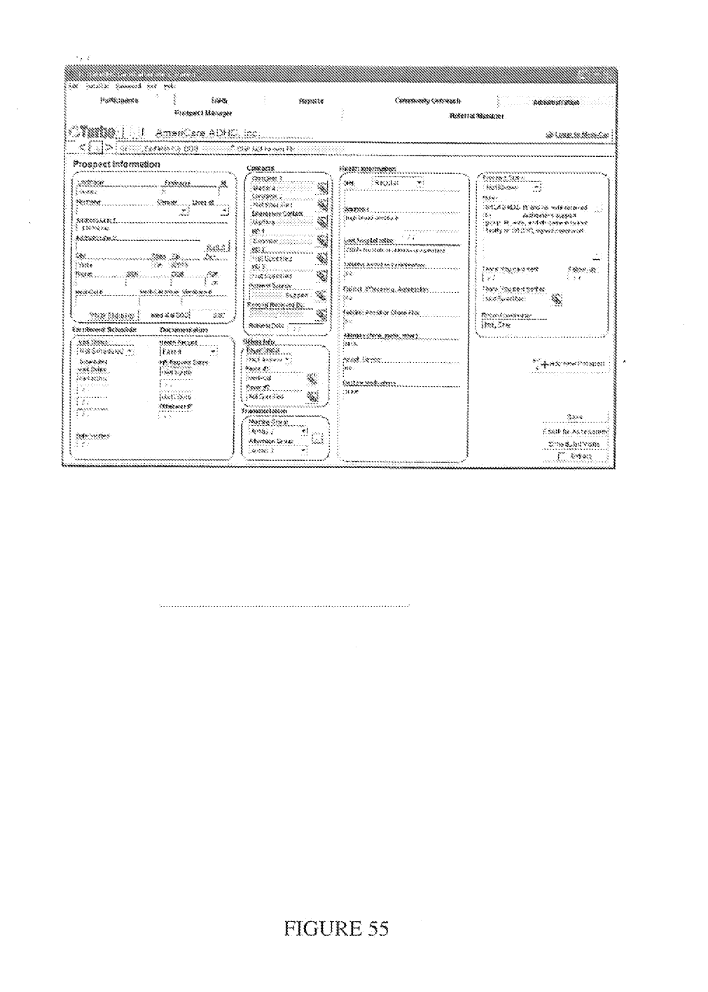

FIG. 54A shows a screenshot of the Community Outreach (“CO”) functionality that may be used to track prospective participants, follow-up on referrals, and/or prepare a participant for possible admission into an ADHC program. FIG. 55 shows a screenshot of a Project Manager (“PM”) that is activated by selecting the CO tab. The PM may be configured to organize demographic information, schedule a visit or enrollment days, record prospect contacts, record health information, track document collection, enter billing information, track prospect status, and follow-up contact. A prospect may become a new participant by selecting “Enroll for Assessment” button.

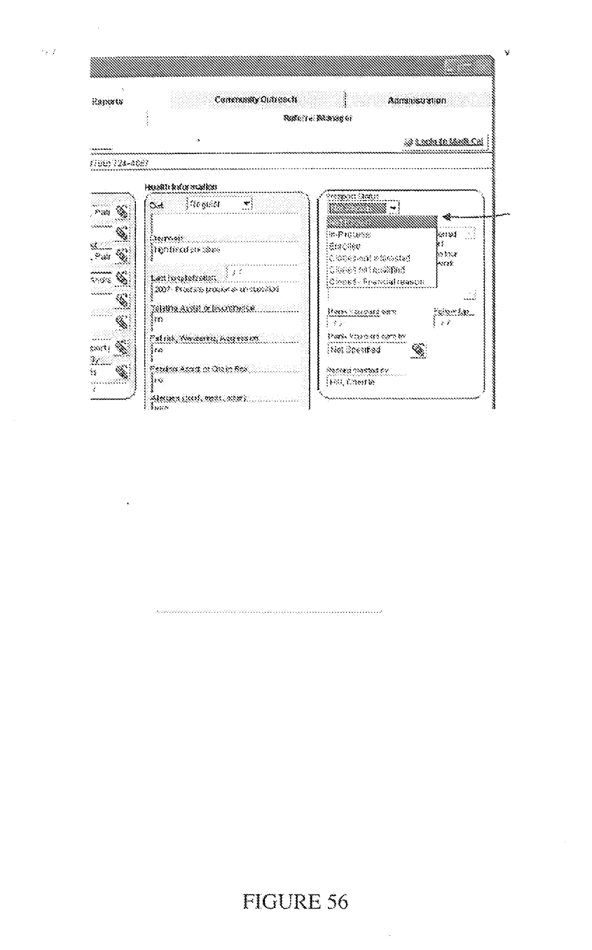

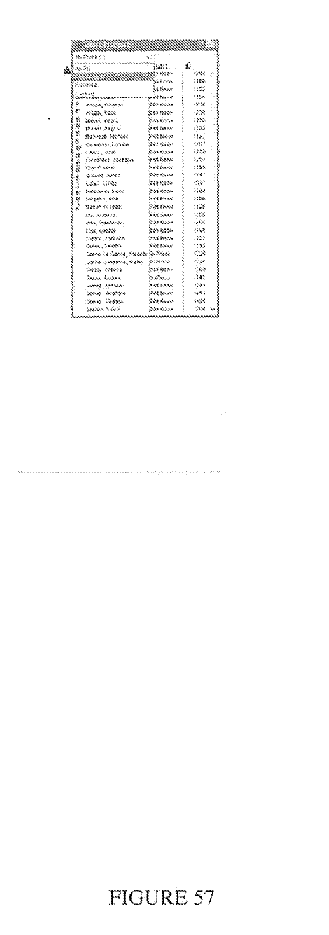

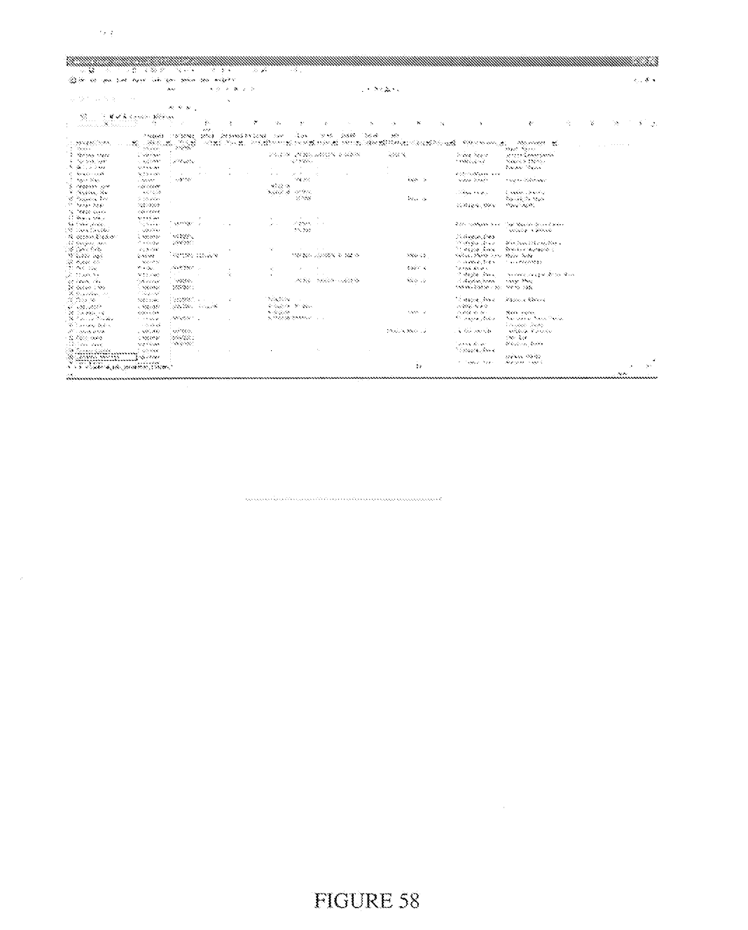

FIGS. 55-58 show an example workflow for adding checking the status, and generating a report for a prospect. FIG. 55 shows an example of the prospect manager module. As shown in FIG. 56, the prospect's name may be entered manually or automatically in the fields. FIG. 57 shows how to search for the status of a prospect. Such statuses are important because they help discern which prospects to follow-up with, who is currently closed and why, and who is on hold and why. FIG. 58 illustrates a screenshot of a prospect may be exported into a program such as excel or suitable program and show prospect status (enrolled, closed, etc.), visit dates, follow-up date, health record requests, who received the referral, and who referred the prospect.

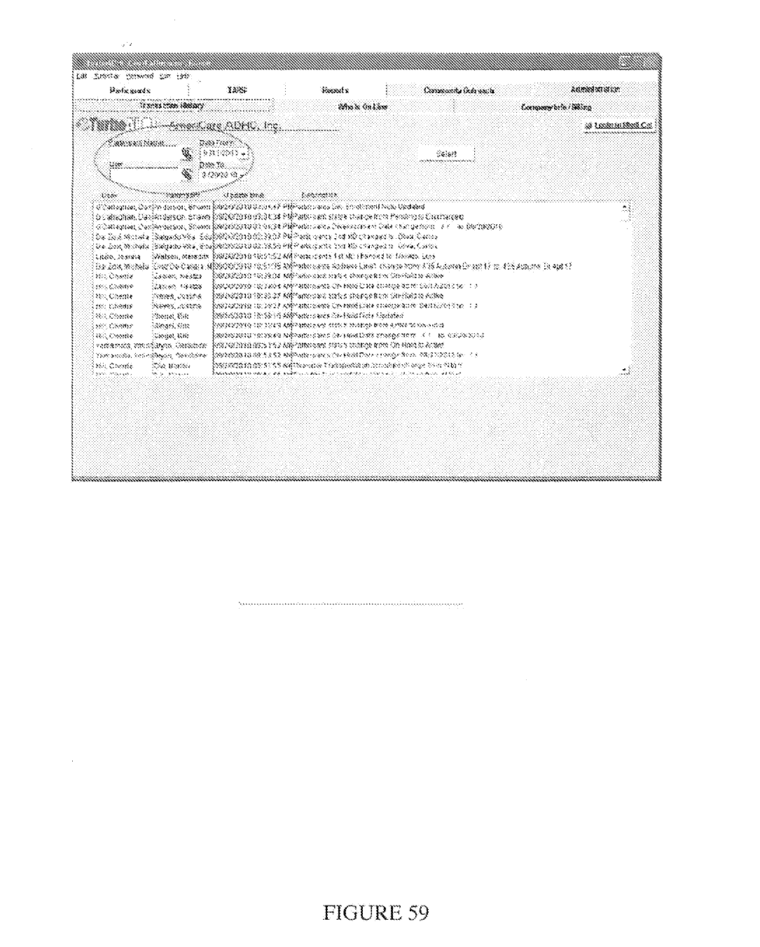

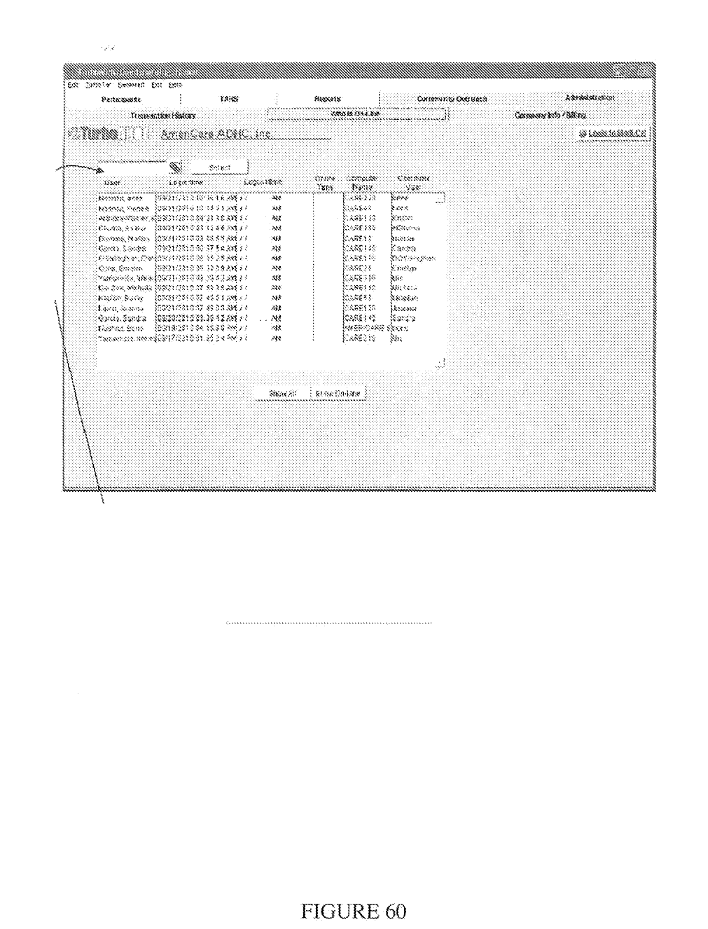

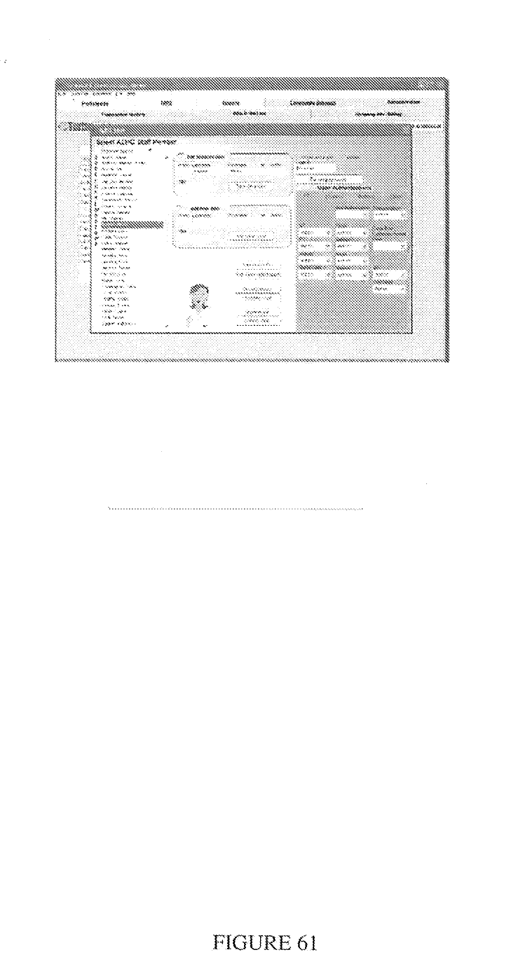

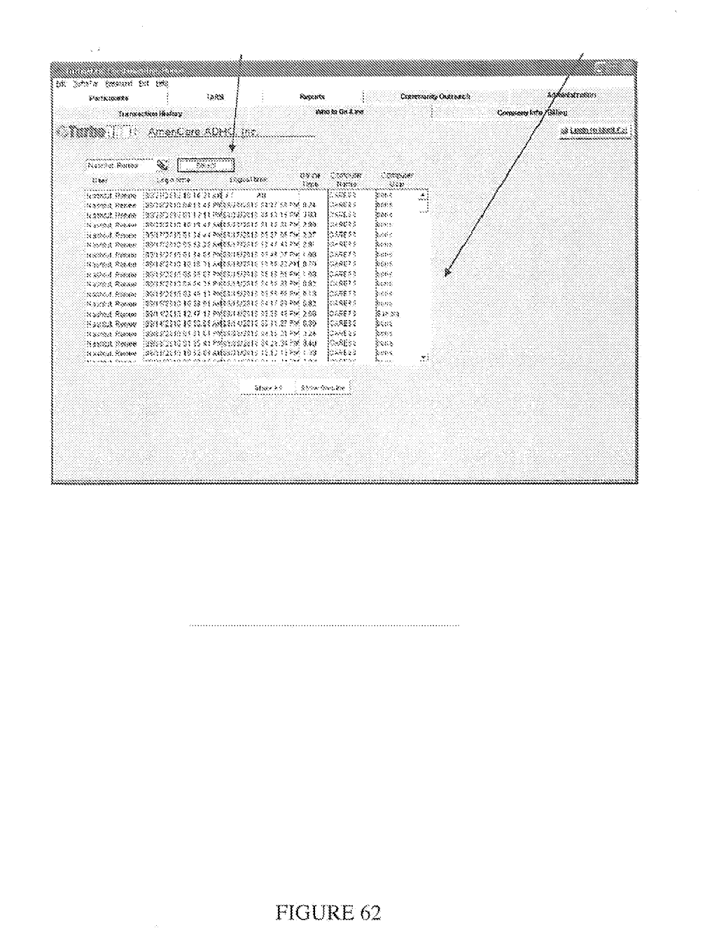

FIG. 59 illustrates a Transaction History (“TH”) page that may be activated by selecting the appropriate tab. The TH may be configured to track demographic changes, schedule pick-ups, track patient assignments, and track participant medical, billing, and dietary changes. FIGS. 60-62 describe a workflow for determining a user's login history or monitor what users are currently using the system. The system may be configured to support one or more users depending on system requirements.

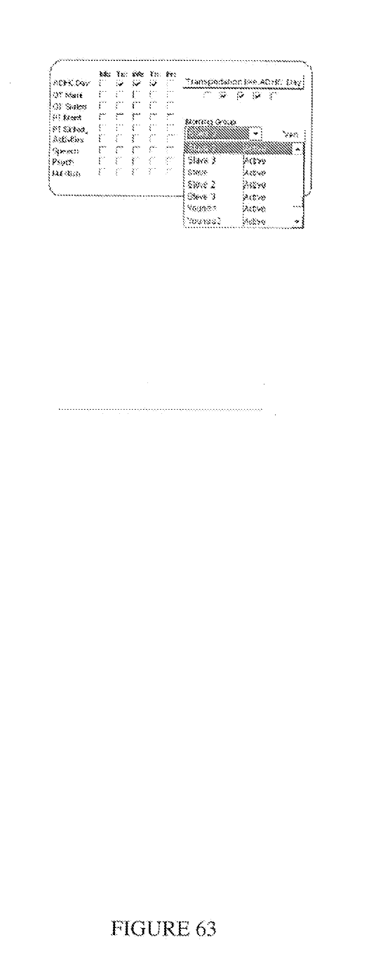

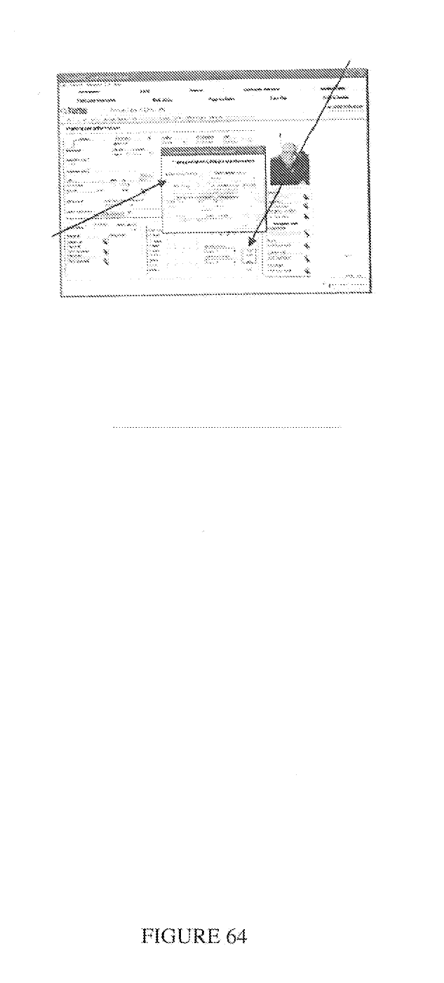

FIGS. 63-64 show a workflow for providing transportation for a participant. The transportation information may be input manually or automatically and may be selected from a drop down menu. Transportation group may also be added to the system, as shown in FIG. 64.

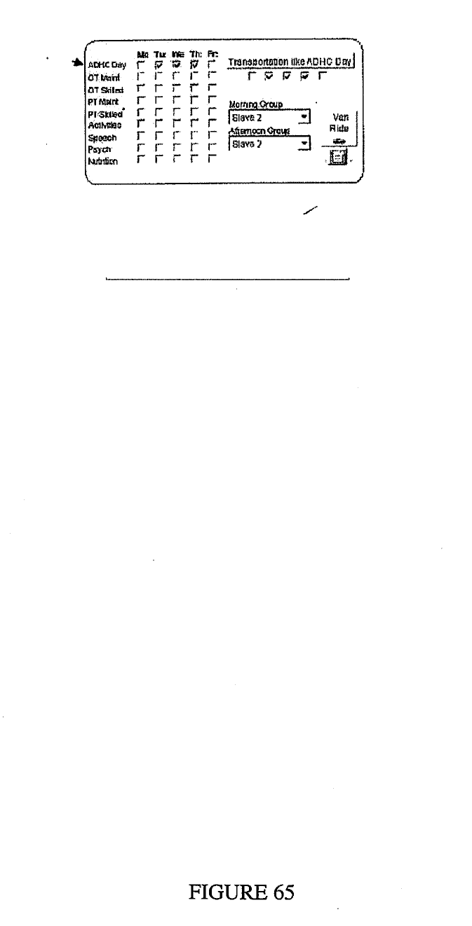

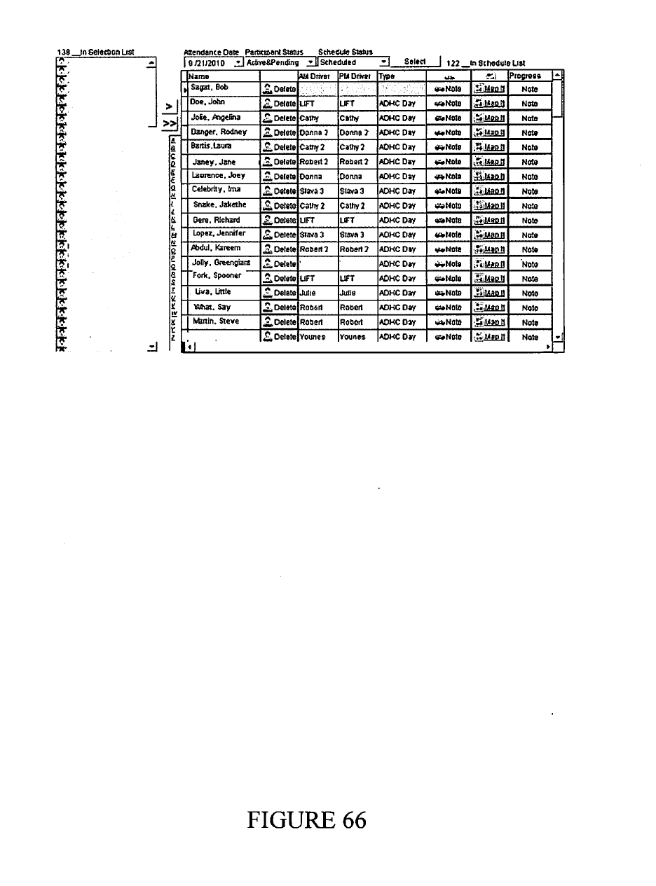

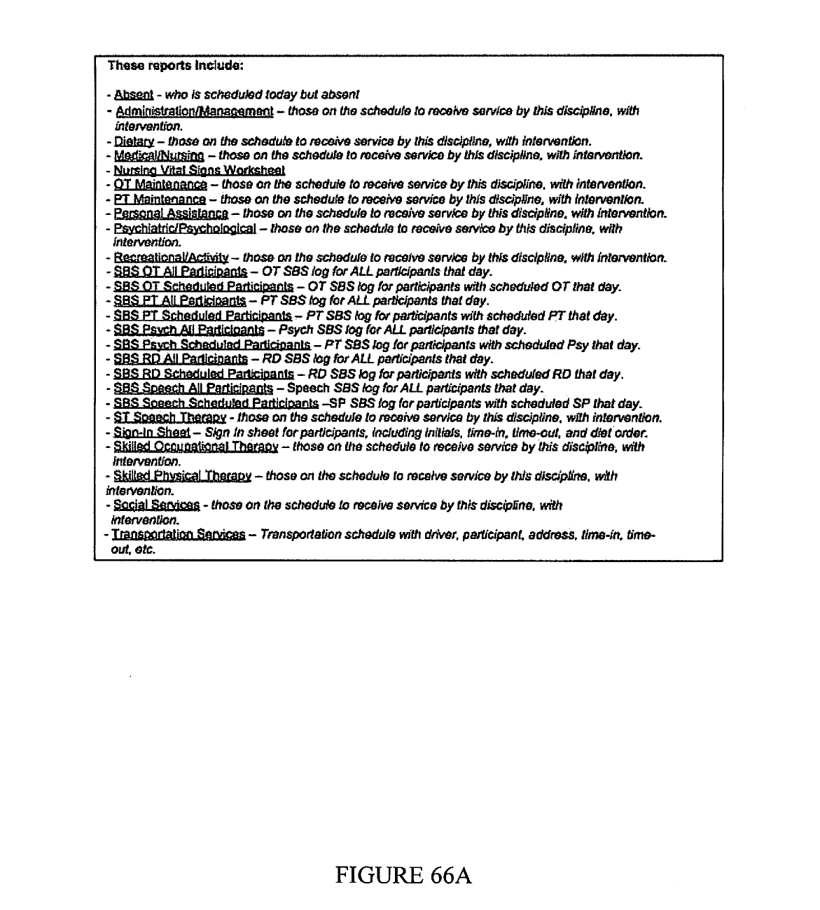

FIGS. 65-66A illustrate a workflow for monitoring the daily schedule of participants. The daily schedule system may be configured to operate with the daily schedule functionality. The daily schedule layout of FIG. 66 may include functionality, such as a selection list, adding one participant, adding all participants, choosing a schedule date, choosing to view participants by status of schedule status, and total number of participants. As shown in FIG. 65, the schedule tab allows users to print multiple reports such as; treatment schedule (all disciplines), Morning Sign-In Sheet, Daily Vital Sheets, Transportation Schedule, etc. FIG. 66A illustrates exemplary reports that may be printed.

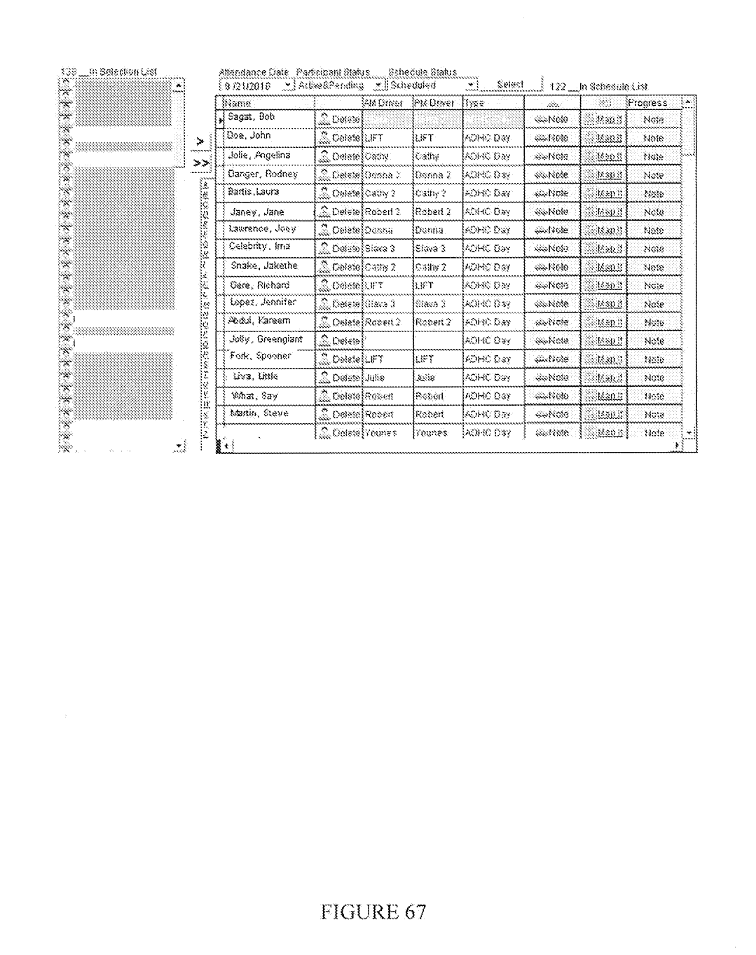

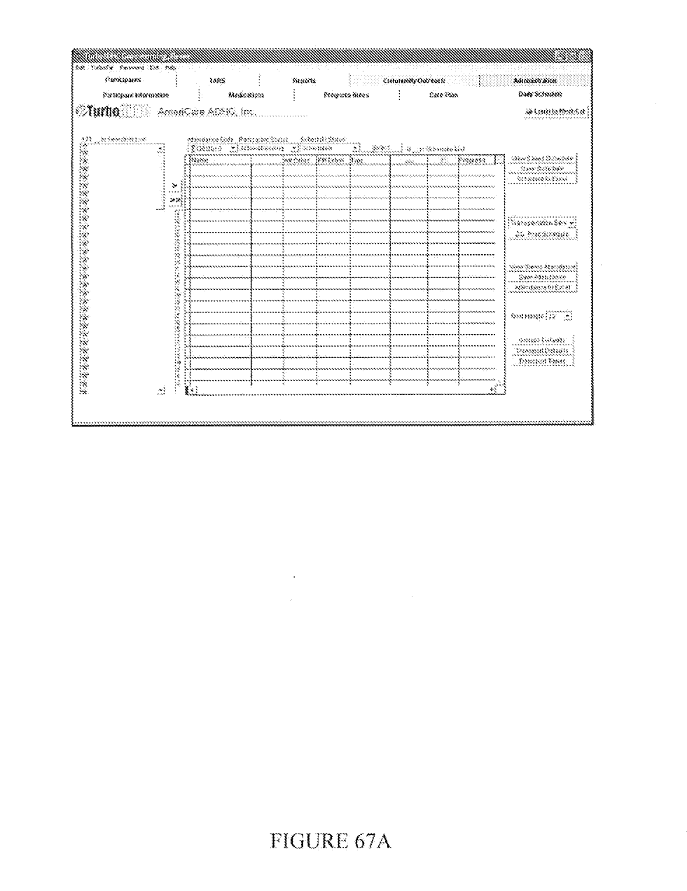

FIG. 67 illustrates an example of a grid in an embodiment. Once a have added participants to the grid, a change may be made about a driver, day type, and notes for that day. Information may also be deleted.

FIG. 67A illustrates a flow of how to create a schedule. A schedule may be added to, deleted from, and changed in any way to ensure accuracy of participants. The schedule may be saved and used as a sign in sheet.

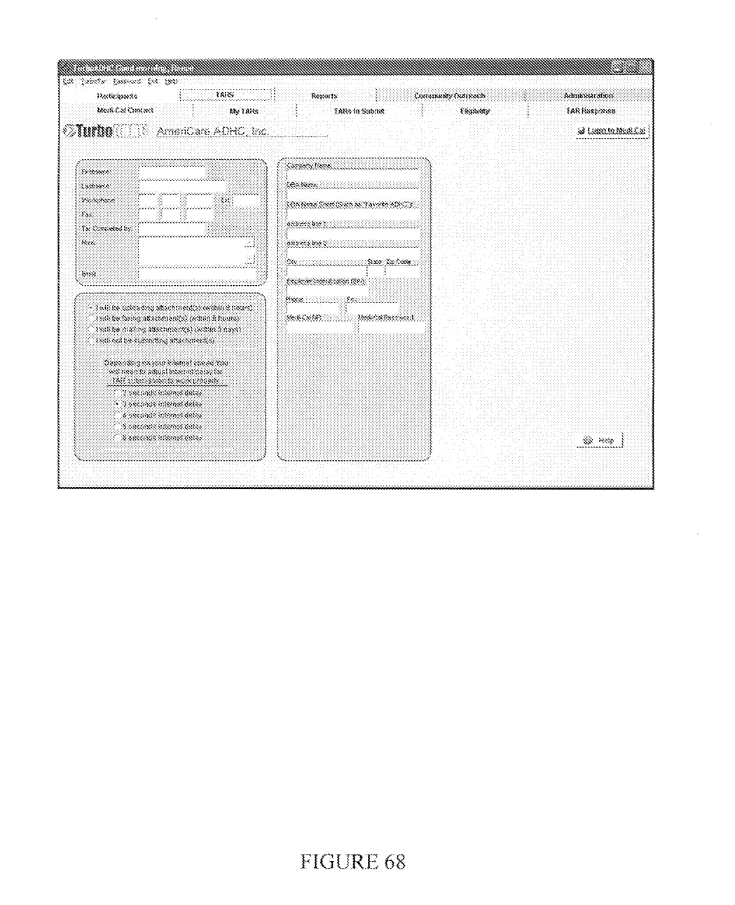

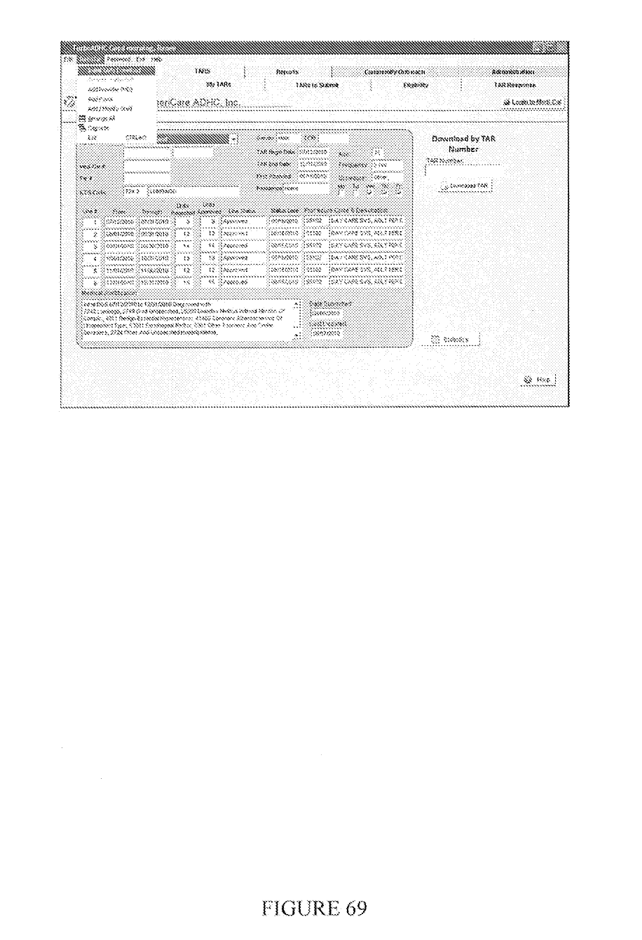

FIGS. 68-72 illustrate a workflow using the TAR screen. A shown in FIG. 68, the TAR screen may be activated by selecting the TAR tab. In one embodiment, the TAR screen may be configured to accept information, such as Medi-Cal contact information. The information may include information about a program director, name of the company, and type of internet connection. FIG. 69 illustrates The “My TARs” screen is a repository of all the TARs that have been sent according to EDS records. These are obtained by the system by completing an “Initial TARs download.” This collects all submitted TAR records from the EDS website. This allows you to see the TAR history on all the TARs that have been submitted.

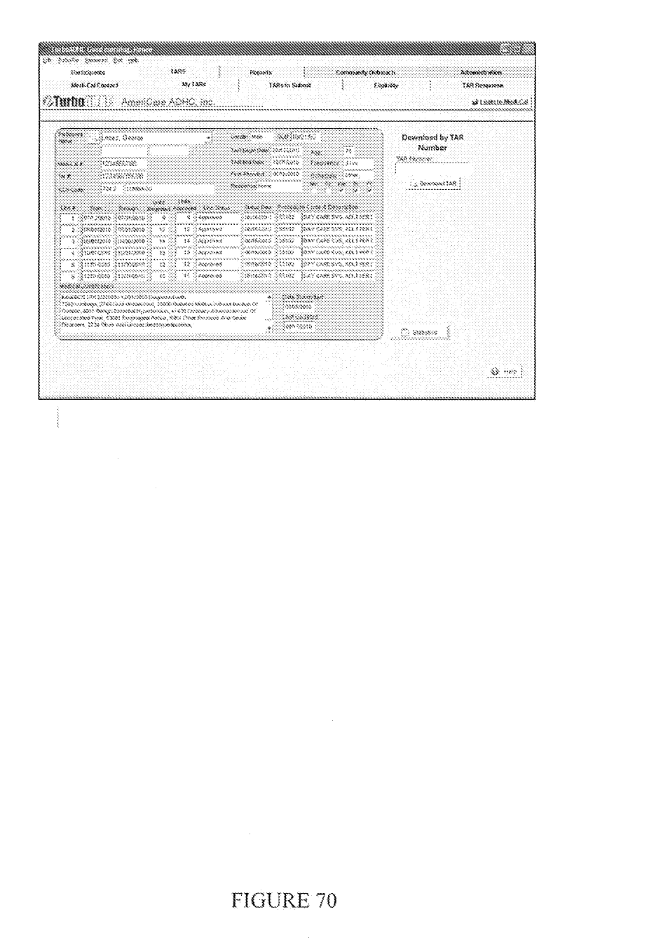

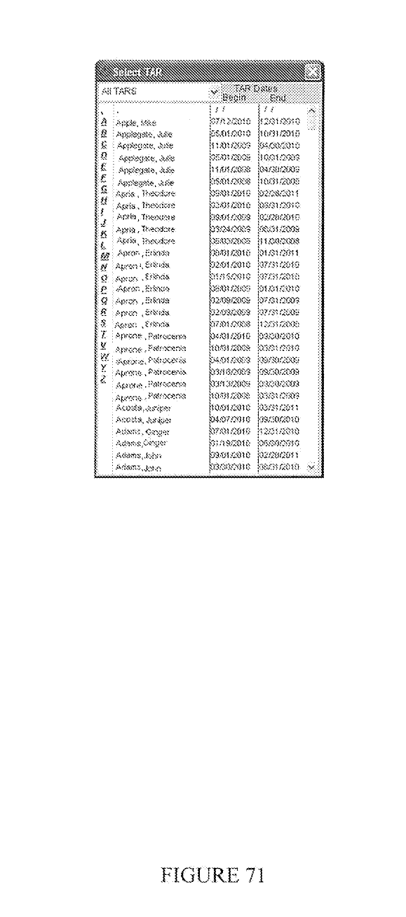

FIGS. 70-71 illustrate examples of the “My TARs” screen that enables a search for a particular TAR. The search may be performed by name, TAR number, etc.

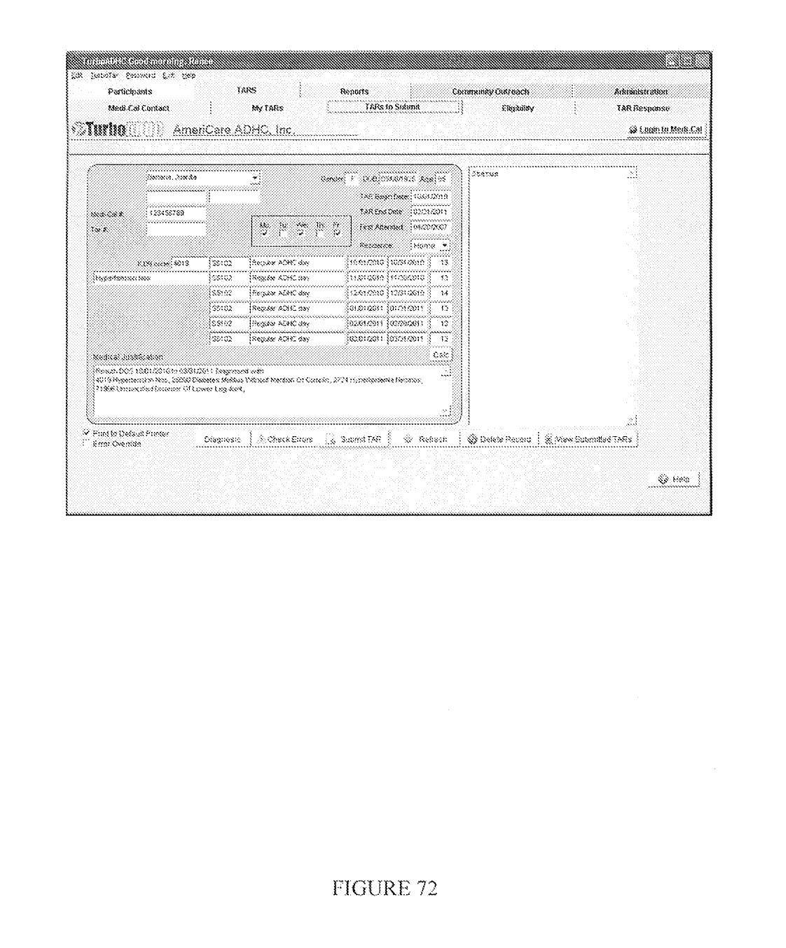

FIG. 72 illustrates a TAR that may be submitted to a government agency or other entity. The TAR may be automatically populated with the relevant codes and participant information. A TAR may be also be automatically detected if it has been submitted. The TAR may be checked for errors automatically. Errors may be compiled and submitted the user for correction. Attachments may also be added to the TAR before submission.

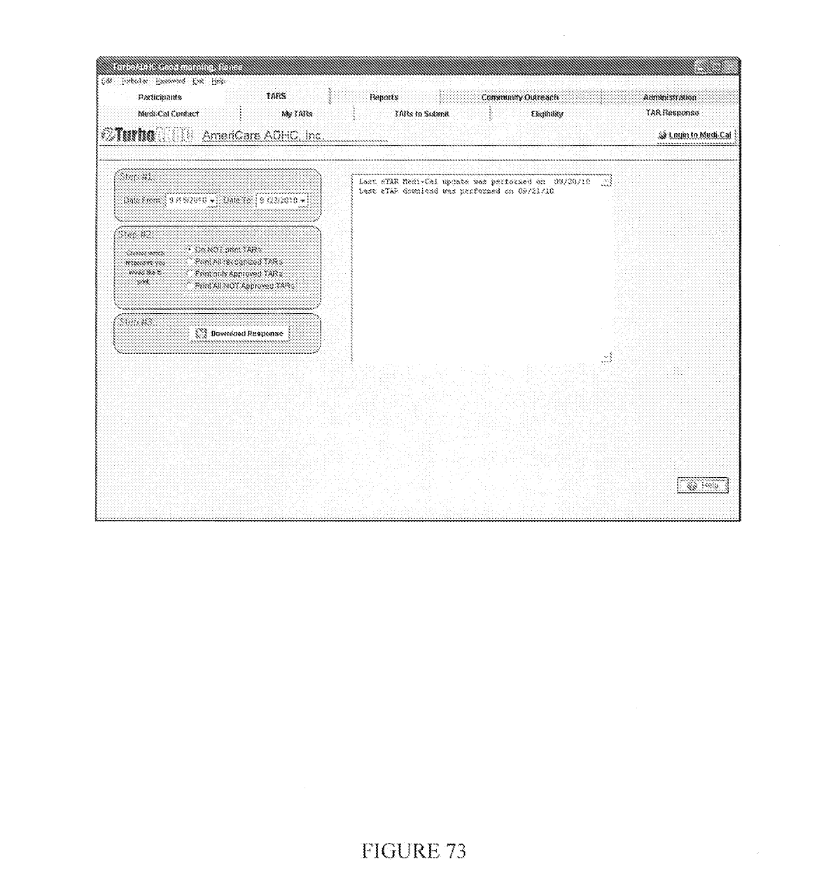

FIG. 73 illustrates an example screenshot of a TAR form that has been updated after submission. The information that has been altered may be automatically populated and updated.

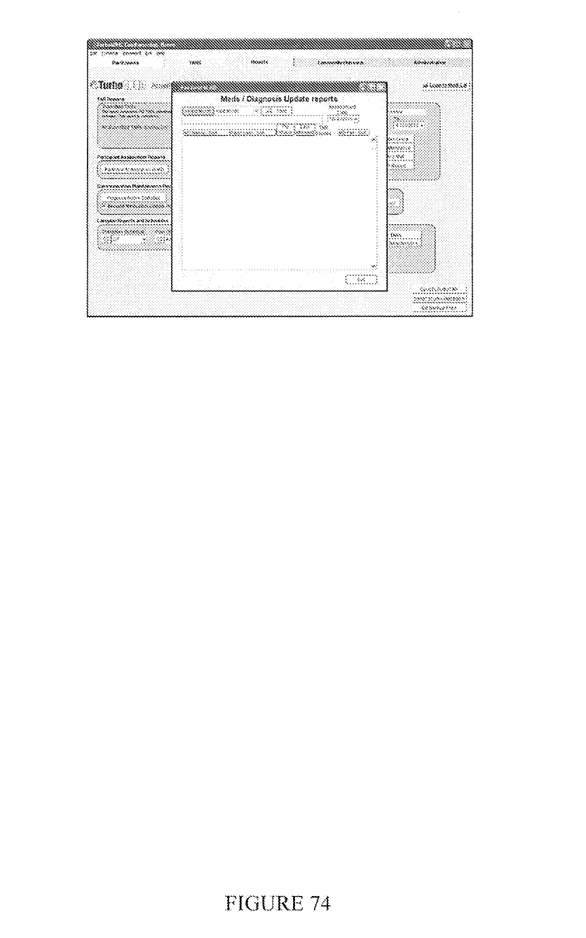

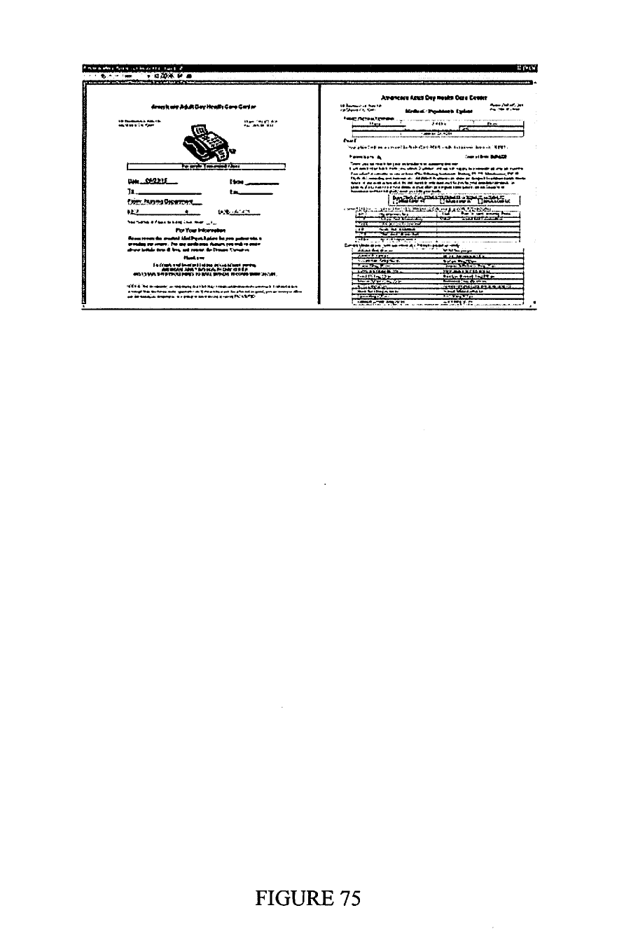

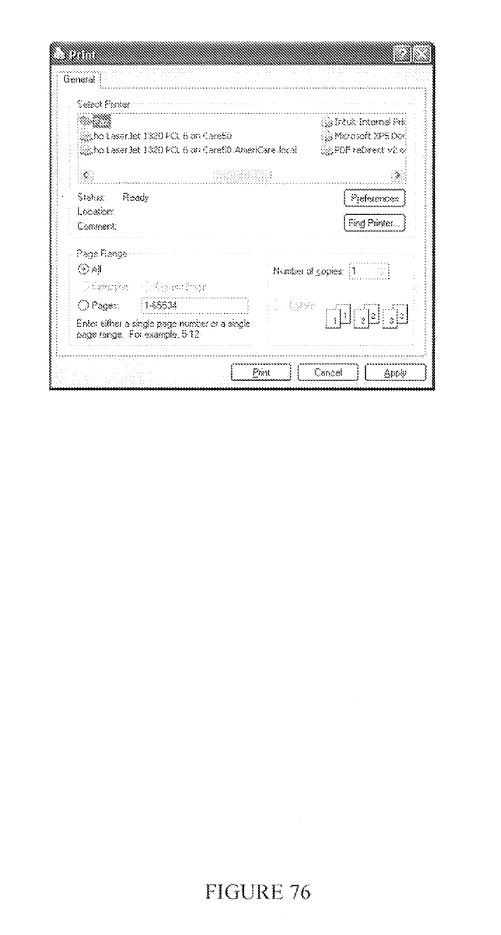

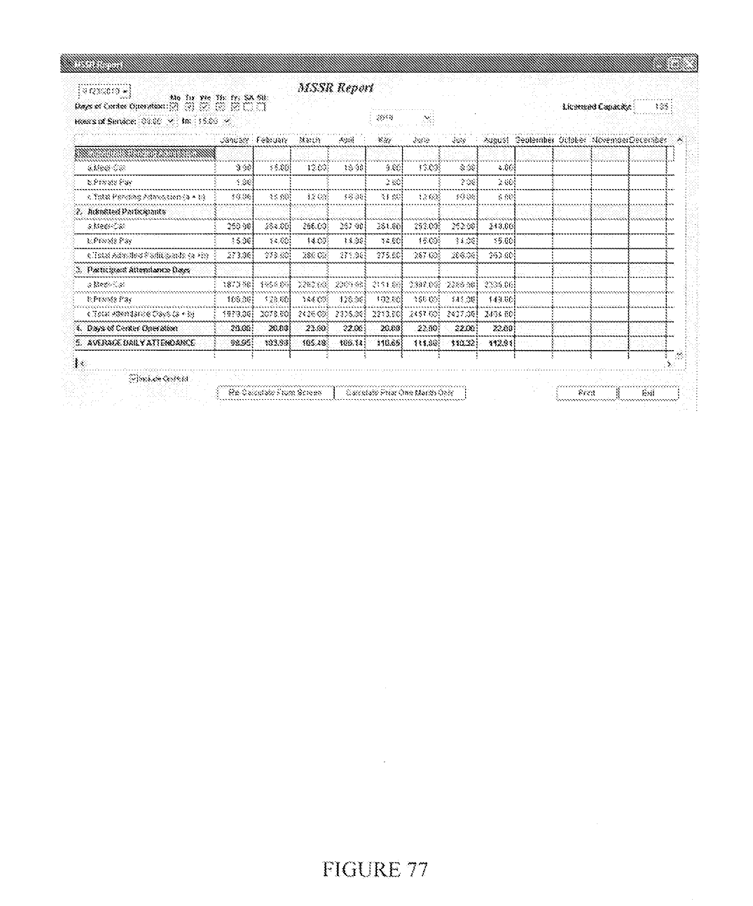

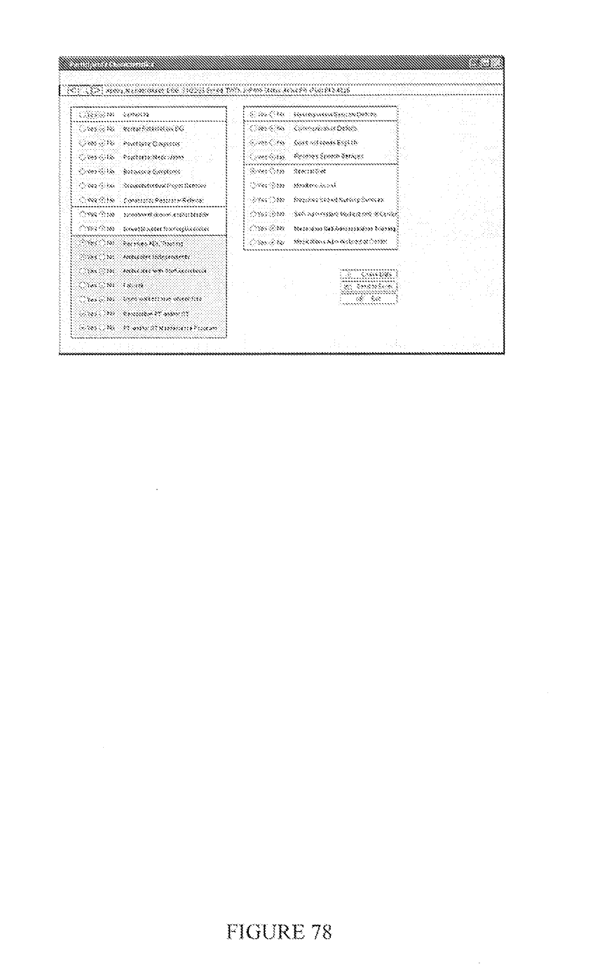

FIGS. 74-76 illustrate how to print a report. In one embodiment, the reports may be preselected before printing by populating a selection list. FIG. 77 illustrates a MSRR report as described below. FIG. 78 illustrates a participant characteristics reports as discussed below Any number and type of reports are suitable for the system. Examples of such reports are found below.

| | | |
|---|---|---|
| TAR Reports | “Submitted | This report shows users all TARs |
| | TARs” | submitted using The system software. It |
| | | is cumulative from the moment you |
| | | started submitting TARs using The |
| | | system. |
| | “All Submitted | Allows users to view a report of all |
| | TARs ending | submitted TARs that expire on the |
| | On” | selected date. |
| | “TAR | Is a report that tells you statistics about |
| | Statistics” | your submitted TARs, including how |
| | | many you have submitted, when your |
| | | last response download was, number |
| | | approved, denied, and modified. |
| Participant | “Participants | This report allows you look at a list of |
| Assignment | Assigned to | participants, created based on a common |
| Reports | MD” | MD. Click on the report and then choose |
| | | your MD. A list will appear in excel with |
| | | all participants assigned to that MD. |
| | “Participants | This report allows you look at a list of |
| | Assigned to | participants, created based on a common |
| | Staff” | assigned Staff Member. Click on the |
| | | report and then choose your Staff |
| | | Member. A list will appear in excel with |
| | | all participants assigned to that staff |
| | | member. |
| Communi- | “Progress | This report gives a list of all participants |
| cation | Notes | and the amount of progress notes they |
| Maintenance | Statistics” | have written in the system for the last |
| Reports | | month, 3 months, and six months. This |
| | | report allows managers to make sure that |
| | | there are notes being done on all |
| | | participants and which need to be |
| | | followed up on. |
| | “Med/Psych | The Med Psych Update is not just a |
| | Update” | report, it is a communication tool |
| | | between each participant and their |
| | | doctor. This is completed every month |
| | | around the 15^{th}, in order to satisfy the |
| | | requirement that the center |
| | | communicates which each participants |
| | | doctor about their condition on a six |
| | | month basis. The update of each |
| | | individuals diagnosis and medication list |
| | | is sent two months before their scheduled |
| | | reauthorization in order to ensure that the |
| | | physician has enough time to verify the |
| | | information and send it back in time for |
| | | the participants reassessment. |
| | “Med/Psych | The Med Psych Update is not just a |
| | Update” | report, it is a communication tool |
| | (FIG. 74) | between each participant and their |
| | | doctor. This is completed every month |
| | | around the 15^{th}, in order to satisfy the |
| | | requirement that the center |
| | | communicates which each participants |
| | | doctor about their condition on a six |
| | | month basis. The update of each |
| | | individuals diagnosis and medication list |
| | | is sent two months before their scheduled |
| | | reauthorization in order to ensure that the |
| | | physician has enough time to verify the |
| | | information and send it back in time for |
| | | the participants reassessment. |
| Careplan | “Therapies | This report(s) consists of OT, OTM, PT, |
| Reports | Schedule” | PTM, Nutrition, and Psych. It will print a |
| and | | report of everyone that is receiving |
| Schedules | | services from the selected program. |
| | “Plan of | This report covers all discipline that have |
| | Care | a careplan. It will print a report of |
| | Intervention” | everyone that is receiving services and |
| | | their careplan from the selected program. |
| | “Birthday | This will print a list of everyone's |
| | List” | birthday for the month, their actual |
| | | birthdates, and the age that they are |
| | | turning. |
| Attendance | “Monthly | The monthly attendance report creates a |
| Reports | Attendance” | list of all participants that have |
| | | attendance that month, with their |
| | | respective attendance dates. Those that |
| | | appear in red are private pay and their |
| | | attendance is marked with a “P”. Blue |
| | | highlighted days signify weekends. Days |
| | | marked “A” signify that this is an |
| | | assessment day. At the bottom of the |
| | | report you will get totals for the month |
| | | and other various counts. |
| | “View | This report is very similar to the monthly |
| | Monthly | attendance report, but includes a couple |
| | Attendance- | more features. This report includes a |
| | Excel” | total of how many days the participant |
| | | attended for the month as well at their |
| | | regular schedule. This report is also |
| | | exported to excel so you have options to |
| | | sort. |
| | “Monthly | This reports has all the features of the |
| | Attendance ++” | above reports, plus it tells you what |
| | | participants had not attendance for the |
| | | month, how many have TARs that were |
| | | not submitted, in review, deferred, or |
| | | denied. |
| | “Monthly | This report list all visitors for the month |
| | Visitors and | and non billable participants, the days |
| | Non Billable” | they came, total number of days, and |
| | | their status. |
| | “Monthly | This reports list all participants, days |
| | Make-Up | approved for the last month, days |
| | Report” | attended, remaining approved days for |
| | | the month, their schedule, driver, as well |
| | | as their contact info and assigned social |
| | | worker. This report is typically used to |
| | | see how many people attended more |
| | | days than they were approved for (non- |
| | | billable). |
| | “Current | This reports list all participants, days |
| | Make-Up | approved for this month, days attended, |
| | Report” | remaining approved days for the month, |
| | | their schedule, driver, as well as their |
| | | contact info and assigned social worker. |
| | “View | This report is based on selecting a |
| | Attendance” | participant and date range. Once you |
| | | select a participant from the drop-down |
| | | menu and a date range you will receive |
| | | an excel report of all attendance days in |
| | | the period you specified. |
| | “Period | This report is based on selecting a date |
| | Attendance” | range. It will show ALL participants |
| | | attendance within a date range. |
| | “Driver | This report exports to excel participants |
| | Statistics” | and their assigned AM and PM driver. |
| | | This report can be used to measure |
| | | drivers productivity by using a pivot |
| | | table in excel (see Microsoft website for |
| | | details on “pivot table“) |
| | “MSSR | This report is a required report by the |
| | Report” | California Department of Aging. It is |
| | | submitted to the Department of Aging on |
| | | a monthly basis. Once you click on the |
| | | “MSSR Report” button, you will see this |
| | | screen appear. |
| Reauthori- | “Reauthori- | Gives you the list of people whose TAR |
| zation and | zation | is ending on the month you choose. This |
| Quarterly | List” | is the list of people you need to complete |
| List | | a Reauthorization for. |
| Report | | |
| | “Quarterly | Gives you the list of people whom you |
| | List” | need to write a quarterly note from on |
| | | the month you choose. |
| Work | “Attended No | This report shows participants with |
| Management | TAR” | accumulated attended days for which |
| Reports | | they have no TAR. |
| | “Check | This report will check careplan |
| | Careplan | completion for all participants. |
| | Completion” | (Careplan completion is understood by |
| | | the check mark at the top right-hand |
| | | corner of the careplan) |
| | “Reauthori- | Gives you the list of people whose TAR |
| | zation | is ending on the month you choose. This |
| | List” | is the list of people you need to complete |
| | | a Reauthorization for. |
| | “Quarterly | Gives you the list of people whom you |
| | List” | need to write a quarterly note from on |
| | | the month you choose. |
| Work | “Attended No | This report shows participants with |
| Management | TAR” | accumulated attended days for which |
| Reports | | they have no TAR. |
| | “Check | This report will check careplan |
| | Careplan | completion for all participants. |
| | Completion” | (Careplan completion is understood by |
| | | the check mark at the top right-hand |
| | | corner of the careplan). |
| | “Not Approved | This report is most informative for |
| | for Billing” | program directors and administrators. |
| | | This report will highlight all participants |
| | | who currently are not billable for the |
| | | following reasons: TAR is in review, |
| | | TAR is deferred, TAR has not been |
| | | submitted. This report will also include |
| | | the number of days that the participant |
| | | has attended the program and has not |
| | | been billable. It gives staff an automatic |
| | | to-do list of those participants who need |
| | | to be addressed immediately because |
| | | they are attending the program and are |
| | | not billable. |
| | “All | This report list all participants and all |
| | Participant | TARs and statuses (approved, In Review, |
| | TARs” | Deferred) for the current month. |
| | “Participant | This report is another statistical report |
| | Character- | that is required (by request) by the |
| | istics” | California Department of Aging. This |
| | | report needs to first be completed |
| | | manually, and then outputted to excel. |
| | “Send Food | This report is completed for the |
| | Roster to | Department of Education, Food Program. |
| | Excel” | If you receive supplemental funding |
| | | from the department of Education to |
| | | supplement your food program, you must |
| | | print this report on a monthly basis. This |
| | | report lets the Department of Education |
| | | what participants are eligible for the food |
| | | program every month. To run this report |
| | | for a particular month simply select any |
| | | day in the “Base Month” drop-down |
| | | menu and then click the “Send Food |
| | | Roster to Excel” button. |

Below describes an example of the files that may be configured into the system. As explained above, the files may be called one or more at a time upon execution of a loader file. Each file may point to one or more other files, thereby advantageously minimizing processing, start-up and execution times. In this way, the system may provide a simply and seamless process for the user.

| FILE | DESCRIPTION |
|---|---|
| Attend File | Has unique identifier, connected to Pparticip, Bildet, Rrprov, User |
| Bildet File | Has unique identifier, connected to Pparticip, Attend, Rrprov, Tarresp3, |
| | Billbatch, User |
| Billbatch File | Has unique identifier, connected to Pparticip, Bildet, User |
| Changlog File | Has unique identifier, connected to Pparticip, User |
| Contacts File | One record file, has company info |
| Diagnosis File | Contains all billable ICD9 Codes, connected to Tar1 by ICD9 code |
| Etarweekly File, | Extract from TAR1 file has pointer to TAR1 file and participant file |
| Contains information | |
| for tars to be | |
| submitted | |
| Favorite File | Favorite plancare items from the library by user |
| Loginid File | Contains information on login history and who is currently on line |
| Lplancare File | Plancare library file |
| Medslib File | Library of medications so users do not have to enter medication name but |
| | able to select from library |
| Parmeds File | Connected to participant file and medication library file and contains |
| | medications for each participant |
| Plancare File | Connected to participant file and TAR1 file contains plancare items for |
| | participant for TAR period |
| Pparticip File | Contains participant information and connected to most other files |
| Prognotes File | Connected to participant file and service type file |
| Rrprov File | Provider file connected primarily to participant file and contains various |
| | provider information such as doctors, caregivers, payers |
| Sched File | Schedule file generated records every day for participants scheduled |
| | attendance |
| Servtype File | Service type file includes all IPC disciplines |
| Setting File | Contains various system setting to optimize system performance |
| Submitted tars File | Updated every time new TAR is submitted and contains submitted TARs |
| | information |
| Subscr1 File | Subscription file contains unique password to allow users to use the |
| | system, used to stop system usage for non-paying clients |
| Tar1 File | Contains information on TAR and connected to participant file also |
| | pointer to plancare file to identify which plancare items belongs to which |
| | tar period. Contains participants diagnosis information and information |
| | required by Title 22 and Med-Cal such as ADL and IDL levels |
| Tarresp3 File | File generated by downloading TAR information from Medi-cal website, |
| | used in billing to identify what can be billed |
| Ttgroup File | Transportation groups file contains information on active and inactive |
| | groups |
| Users File | Contains login and password for system user |

### CONCLUSION

The system described above has several commercial advantages. Eligibility verification functionality. For example, TARs may be submitted in real time and real time responses may be retrieved. The system also provides multiple levels of verification checks of the data to avoid errors in processing which are typically found in many systems. In one example, the system may verify a type of data, authenticate a user, and/or use an electronic signature. The system also uses an integrated software platform and backend as described herein that enables data to be automatically populated and updated without user intervention. This avoids duplicative data entry.

The integrated software platform and backend further enable compact, logical design to eliminate unnecessary system navigation, minimize user training. It also provides streamline business system processes and reporting to indicate next necessary process. In addition, the system may be configured to disallow duplicate records to prevent incorrect billing and billing with single click functionality.

The system also enables for seamless data verification using single click functionality to ensure that the required information for billing is accurate for one or more participants, and data verification to ensure Health Department compliance and Title XXII to verify plan of care completeness and existence of flow sheets The system may also be configured to create work assignments for professional staff based on necessary regulatory compliance

The system may be further configured to create a schedule of TARs to submit to healthcare and regulatory entities for review and authorization. The system may also be configured to perform automated scheduling for prospective client transportation and sign-in attendance and flag any potential conflicts and/or issues.

The invention illustratively disclosed herein suitably may be practiced in the absence of any element, part, step, component, or ingredient which is not specifically disclosed herein.

Although the system is depicted with various components, one skilled in the art will appreciate that the servers can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM or other forms of RAM or ROM. The computer-readable media may include instructions for a controlling a system to perform a particular method described herein.

In relation to certain preferred embodiments thereof, and many details have been set forth for purposes of illustration, it will be apparent to those skilled in the art that the invention is susceptible to additional embodiments and that a certain of the details described herein can be varied considerably without departing from the basic principles of the invention.

A computer-implemented device system and method for creating, managing, and processing an interactive workflow is described to handle patient data. A client having various modules may be installed on a computing device. The modules of the client may be adapted to receive and transmit communications by way of various communication methods. The client may be in direct or indirect communication with a server, which includes one or more databases and a host application having various modules and engines that facilitate communications between a user and one or more entities associated with healthcare including insurers, patients, doctors, physical therapists occupations therapists, speech therapists, allied healthcare professionals, nurses or other skilled professionals.

What is claimed is:

1. A device, comprising:
a processor configured to execute a set of instructions for performing a method of reporting patient data, the method comprising:
receiving a plurality of patient data;
processing the patient data to generate at least one treatment authorization request;
verifying one or more types of the content of the treatment authorization request;
submitting the treatment authorization request in real time to a government entity for approval.

2. The device of claim 1, wherein the method further comprises confirming the accuracy of the content.

3. The device of claim 1, wherein the method further comprises updating the content using one or more codes associated with one or more treatments.

4. The device of claim 1, wherein the method further comprises generating a billing report.

5. The device of claim 4, wherein the method further comprises reconciling the content to determine one or more errors.

6. The device of claim 1, wherein the method further comprises providing and/or updating content that tracks the progress of a patient.

7. A method, comprising:
receiving a plurality of patient data;
processing the patient data to generate at least one treatment authorization request;
verifying one or more types of the content of the treatment authorization request;
submitting the treatment authorization request in real time to a government entity for approval.

8. The method of claim 7 further comprising confirming the accuracy of the content.

9. The method of claim 7 further comprising updating the content using one or more codes associated with one or more treatments.

10. The method of claim 7 further comprising generating a billing report.

11. The method of claim 7 further comprising reconciling the content to determine one or more errors.

12. The method of claim 7 further comprising providing and/or updating content that tracks the progress of a patient.

13. A system, comprising:
a database configured to store patient data;
a server coupled to the database; and
a processor coupled to the server including one or more modules for reporting a treatment authorization plan in real time.

14. The system of claim 13 wherein the processor is configured to confirm the accuracy of the treatment authorization plan.

15. The system of claim 13 wherein the processor is configured to update the treatment authorization plan using one or more codes associated with one or more treatments.

16. The system of claim 13 wherein the processor is configured to generate a billing report.

17. The system of claim 13 wherein the processor is configured to search for one or more errors associated with the content.

18. The system of claim 13 wherein the processor is configured to provide content that tracks the progress of a patient.
